(19) United States
(12) Patent Application Publication
(10) Pub. No.: US 2025/0153236 A1
(43) Pub. Date: May 15, 2025

(54) METHOD AND SYSTEM FOR JOINING WORKPIECES

(71) Applicant: Paul Po CHENG, London (CA)

(72) Inventor: Paul Po CHENG, London (CA)

(21) Appl. No.: 18/947,039

(22) Filed: Nov. 14, 2024

Related U.S. Application Data
(60) Provisional application No. 63/599,055, filed on Nov. 15, 2023.

(51) Int. Cl. B21D 39/03

(52) U.S. Cl. CPC B21D 39/031

(57) ABSTRACT

A method of joining first and second workpieces together. The first and second workpieces have respective first and second engagement surfaces thereof. First and second heated portions of the first and second workpieces that are adjacent to the first and second engagement surfaces are heated to one or more hot working temperatures, at which the heated portions are plastically deformable. One or both of the first and second engagement surfaces is formed to limit heat transfer from the first and second heated portions into respective body portions contiguous therewith. While the first and second heated portions are at the hot working temperature(s), the first and second heated portions are engaged with each other and urged together, and one or both of the workpieces are moved relative to the other, for at least partial plastic deformation of the first and second heated portions to join the first and second workpieces together.

### CROSS-REFERENCE TO RELATED APPLICATION

This application claims priority from U.S. Provisional Patent Application No. 63/599,055, filed on Nov. 15, 2023, the entire disclosure whereof is hereby incorporated by reference herein.

### FIELD OF THE INVENTION

The present invention is a method for joining workpieces.

### BACKGROUND OF THE INVENTION

As is well known in the art, conventional welding techniques applied to relatively thick aluminum workpieces (e.g., approximately ½ inch thick) often do not achieve satisfactory results. One problem is that the conventional aluminum welding methods typically result in gases within the weld, foaming inside the temporarily molten aluminum. As a result, conventional aluminum welds typically are somewhat porous, and cracking is common. Also, conventional welding techniques generally involve melting metal, and when the melted metal solidifies, a heat-affected zone of weakness in the weld results.

In the prior art, solid state fusion of workpieces made of other materials (e.g., steel) may be achieved by, first, heating portions thereof to a hot working temperature or a range of hot working temperatures (i.e., a temperature or temperatures below melting temperature), at which the portions are subject to plastic deformation. The heated portions of two workpieces are then engaged together. One or both of the two engaged heated portions thereof is moved relative to the other while urged together, and while the heated portions are at the hot working temperature, for plastic deformation thereof, to metallurgically bond the workpieces together. For example, U.S. Pat. No. 6,637,642 discloses a method of solid state welding.

In the known processes of solid state fusion, because the engagement of the engagement surfaces while there is relative movement of one or both of them occurs while the engagement surfaces thereof are plastically deformable, the prior art processes generally are intended to be completed within a relatively short period of time, after the heated portions are heated to the hot working temperature. Even if the materials have relatively low thermal conductivity (k), engagement and relative movement are required to be achieved within a limited time period during which the heated portions are plastically deformable, depending on how quickly the heated portions cool to a temperature below the range of hot working temperatures.

Where only a portion of a solid is heated, there is a temperature difference in the solid and a heat flow takes place across the temperature difference. The rate of heat transfer (or dissipation) from the heated portions depends on a number of factors. In general, the relatively rapid loss of heat from the heated portions is due to heat transfer by conduction from the heated portions of the respective workpieces to the other portions thereof, which are connected to the respective heated portions. A number of parameters may affect the rate of energy transport across a thermal gradient.

The thermal conductivity of the workpiece is largely determined by the material (e.g., steel) the workpiece is made of. Where the workpieces are made of steel, because the thermal conductivity of steel is relatively low (e.g., approximately 45 W·m⁻¹·K⁻¹ for carbon steel), there is usually sufficient time to complete solid state fusion before the temperature of the heated portions has fallen below the hot working temperature, and is too low for plastic deformation.

However, if one or both of the workpieces includes a material that is highly thermally conductive (e.g., aluminum, with thermal conductivity of about 237 W·m⁻¹·K⁻¹, or copper, with thermal conductivity of about 401 W·m⁻¹·K⁻¹ at atmospheric pressure and at about 20° C.), then the known solid state fusion methods may not succeed, because the heated portions may lose heat so quickly that they are not plastically deformable for a sufficiently long time while they are engaged.

### SUMMARY OF THE INVENTION

For the foregoing reasons, there is a need for a method for joining workpieces where one or more of the workpieces has high thermal conductivity that overcomes or mitigates one or more of the defects or deficiencies of the prior art.

In its broad aspect, the invention provides a method of joining first and second workpieces together. The workpieces have respective first and second engagement surfaces thereof. First and second heated portions of the first and second workpieces that are adjacent to the first and second engagement surfaces are heated to one or more hot working temperatures, at which the heated portions are plastically deformable. The hot working temperatures are below the melting point of the material. One or both of the first and second engagement surfaces is formed to limit heat transfer therefrom into a body portion contiguous therewith. While the heated portions are at the hot working temperature(s), the first and second heated portions are engaged with each other and urged together, and one or both of the workpieces are moved relative to the other, for at least partial plastic deformation of the heated portions, to join the first and second workpieces together with a metallurgical bond. Because the material is not melted, the bond does not include a heat-affect zone of weakness.

The workpieces may be made of highly thermally conductive material. Alternatively, one or both of the workpieces may be made of material that is not highly thermally conductive. The material of one or both workpieces may be metal (e.g., aluminum, copper, or steel), or a non-metal (e.g., ceramic).

### BRIEF DESCRIPTION OF THE DRAWINGS

The invention will be better understood with reference to the attached drawings, in which:

FIG. 1A is a partial cross-section of embodiments of first and second workpieces having first and second engagement surfaces facing each other and aligned with each other, with a heating element positioned therebetween;

FIG. 1B is a cross-section of the first and second workpieces of FIG. 1A in which the first and second engagement surfaces are engaged with each other;

FIG. 1C is a cross-section of the first and second workpieces of FIGS. 1A and 1B in which the workpieces are joined together to form a product;

FIG. 2A is a partial cross-section of other embodiments of first and second workpieces having first and second engagement surfaces facing each other and non-aligned with each other, with a heating element positioned therebetween;

FIG. 2B is a cross-section of the first and second workpieces of FIG. 2A in which the first and second engagement surfaces are engaged with each other, at selected locations thereon;

FIG. 2C is a cross-section of the first and second workpieces of FIGS. 2A and 2B in which the workpieces are joined together to form a product;

FIG. 3A is a partial cross-section of alternative embodiments of first and second workpieces having first and second engagement surfaces facing each other and aligned with each other, with a heating element positioned therebetween;

FIG. 3B is a cross-section of the first and second workpieces of FIG. 3A in which the first and second engagement surfaces are engaged with each other;

FIG. 4A is a partial cross-section of other embodiments of first and second workpieces having first and second engagement surfaces facing each other and non-aligned with each other, with a heating element positioned therebetween;

FIG. 4B is a cross-section of the first and second workpieces of FIG. 4A in which the first and second engagement surfaces are engaged with each other;

FIG. 4C is a cross-section of the first and second workpieces of FIGS. 4A and 4B in which the workpieces are joined together to form a product;

FIG. 5A is a partial cross-section of other embodiments of first and second workpieces having first and second engagement surfaces facing each other and aligned with each other, with a heating element positioned therebetween;

FIG. 5B is a cross-section of the first and second workpieces of FIG. 5A in which the first and second engagement surfaces are engaged with each other and fit together;

FIG. 5C is a cross-section of the first and second workpieces of FIGS. 5A and 5B in which the workpieces are joined together to form a product;

FIG. 6A is a partial cross-section of alternative embodiments of first and second workpieces having first and second engagement surfaces facing each other, with a heating element and one or more heat shield elements positioned therebetween;

FIG. 6B is a cross-section of the first and second workpieces of FIG. 6A in which the first and second engagement surfaces are engaged with each other;

FIG. 6C is a partial cross-section of alternative embodiments of the first and second workpieces having first and second engagement surfaces facing each other, with a heating element and one or more heat shield elements positioned therebetween;

FIG. 6D is a cross-section of the first and second workpieces of FIG. 6C in which the workpieces are joined together to form a product;

FIG. 7A is a cross-section of other workpieces spaced apart from each other;

FIG. 7B is a cross-section of the workpieces of FIG. 7A in which engagement surfaces thereof are engaged with each other;

FIG. 7C is a cross-section of the workpieces of FIGS. 7A and 7B in which the workpieces are bonded together to form a product;

FIG. 7D is a cross-section of other workpieces spaced apart from each other;

FIG. 7E is a cross-section of the workpieces of FIG. 7D in which engagement surfaces thereof are engaged with each other;

FIG. 7F is a cross-section of the workpieces of FIGS. 7D and 7E in which the workpieces are bonded together to form a product;

FIG. 8A is a cross-section of other embodiments of workpieces formed for engagement, spaced apart from each other;

FIG. 8B is a cross-section of the workpieces of FIG. 8A in which the workpieces are engaged with each other;

FIG. 8C is a cross-section of the workpieces of FIGS. 8A and 8B in which the workpieces are bonded together to form a product;

FIG. 9A is a partial cross-section of embodiments of first and second workpieces having first and second engagement surfaces facing each other, with a heating element positioned therebetween;

FIG. 9B is a cross-section of the first and second workpieces of FIG. 1A in which the first and second engagement surfaces are engaged with each other; and

FIG. 9C is a cross-section of the first and second workpieces of FIGS. 1A and 1B in which the workpieces are bonded together to form a product.

### DETAILED DESCRIPTION

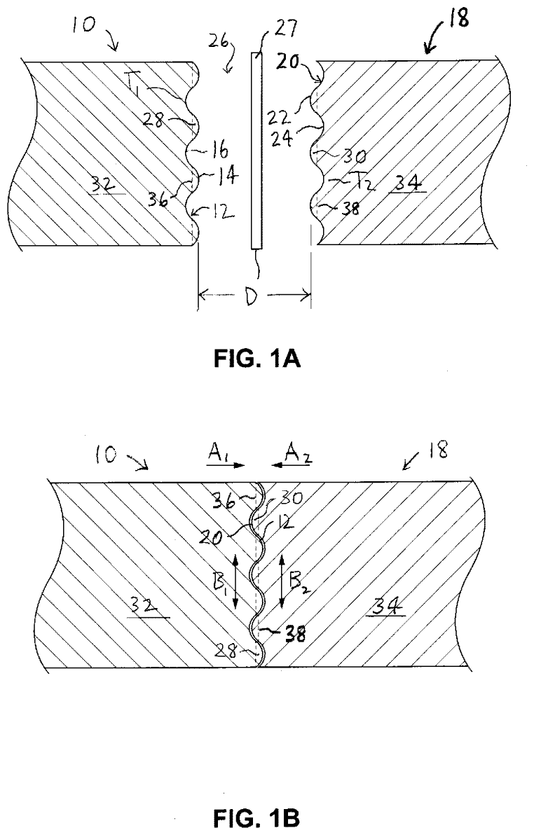

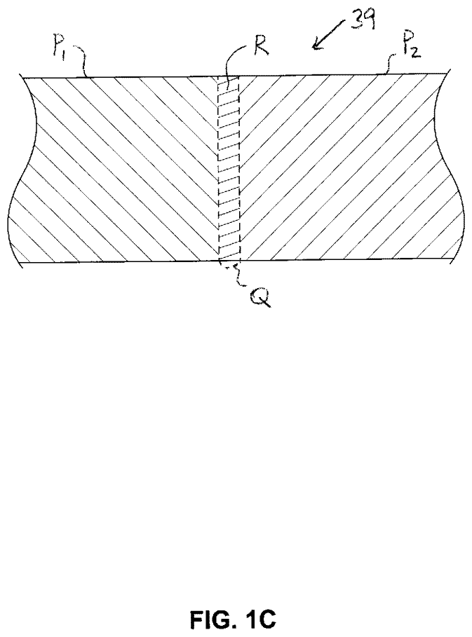

In the attached drawings, like reference numerals designate corresponding elements throughout. Reference is first made to FIGS. 1A-4C to describe an embodiment of a method for joining workpieces in accordance with the invention.

In one embodiment, the method of the invention includes providing a first workpiece 10 having a first engagement surface 12 including a number of alternating first peaks 14 and first troughs 16. Also, a second workpiece 18 is provided that has a second engagement surface 20 including a number of alternating second peaks 22 and second troughs 24. It will be understood that the amplitudes of the peaks and troughs as illustrated in the drawings are exaggerated, for clarity of illustration.

As can be seen in FIG. 1A, the first and second workpieces 10, 18 preferably are positioned a predetermined distance “D” apart from each other to locate the first and second engagement surfaces 12, 20 facing each other to define a gap 26 therebetween. It will be understood that, in one embodiment, the first and second workpieces 10, 18 may be made of a highly thermally conductive material, e.g., aluminum. For the purposes hereof, a highly thermally conductive material is considered to be any material with thermal conductivity that is similar to the thermal conductivity of aluminum or more, e.g., copper.

Those skilled in the art would appreciate that, the method of the invention may be utilized with materials that are not highly thermally conductive. Alternatively, the method of the invention may be utilized if a material that is not highly thermally conductive (e.g., steel, or ceramic) is sought to be joined to a material that is highly thermally conductive. For example, the method of the invention may be utilized where the workpieces are not highly thermally conductive, but it is desirable to have a somewhat slower rate of heat transport across the thermal gradients in the workpieces. Those skilled in the art would also appreciate that although metal workpieces may be heated by induction heating, ceramic workpieces preferably are heated using radiant heating.

One or more heating elements 27 preferably are positioned in the gap 26, for heating respective first and second heated portions 28, 30 of the workpieces 10, 18 to a hot working temperature, at which the first and second heated portions are at least partly plastically deformable. As will be described, the first and second heated portions 28, 30 preferably are located adjacent to the first and second engagement surfaces 12, 20 respectively, at the first and second peaks 14, 22.

Those skilled in the art would appreciate that the hot working temperature is below the melting temperature of the material of the workpieces. It will also be understood that there may be a range of hot working temperatures, at which the heated portions are plastically deformable. It will be understood that a reference herein to a hot working temperature includes any temperature within a range of hot working temperatures.

Preferably, the heated portions 28, 30 are heated by induction heating.

It is preferred the heated portions 28, 30 are initially heated to the hot working temperature. Upon the first and second heated portions 28, 30 being heated to the hot working temperature, respective first and second body portions 32, 34 are thereby defined in the first and second workpieces 10, 18. The first and second body portions 32, 34 are not initially heated to the hot working temperature. It will be understood that the first and second body portions 32, 34 are those parts of the first and second workpieces 10, 18 that are connected to the first and second heated portions 28, 30 that are not initially heated to the hot working temperature. Those skilled in the art would appreciate that, upon the first and second heated portions reaching the hot working temperature, the temperatures of the body portion 32, 34 commence increasing, due to conduction.

The first and second heated portions 28, 30 preferably include the first and second peaks 14, 22. The first and second peaks 14, 22 are formed to limit heat transfer therefrom by conduction into the first and second body portions 32, 34 respectively. It will be understood that, initially (i.e., once the first and second heated portions 28, 30 are first heated to the hot working temperature), the first and second heated portions 28, 30 are proximal to the first and second peaks 14, 22.

For clarity of illustration, dashed lines identified by reference characters 36, 38 in FIGS. 1A and 1B respectively indicate idealized boundaries, (i) between the first heated portion 28 and the first body portion 32, and (ii) between the second heated portion 30 and the second body portion 34, when the heated portions 28, 30 are initially heated to the hot working temperature. As noted above, the first and second body portions 32, 34 are at one or more temperatures that, initially, are less than the hot working temperature. The dashed lines 36, 38 represent the extent of the heated portions 28, 30 at the point when the temperatures of the heated portions have first reached the hot working temperature.

Accordingly, the dashed lines 36, 38 represent points at which the temperature of the body portions 32, 34 are initially less than the hot working temperature. Those skilled in the art would appreciate that the boundaries 36, 38 as illustrated are approximate, in addition to being time-limited. For example, they are represented as rectilinear lines although they may not be so in fact. Those skilled in the art would also appreciate that, in practice, the location of a boundary between a heated portion and the body portion contiguous thereto varies, over a short time period, as heat is transferred (i.e., primarily by conduction) from the heated portion to the contiguous body portion, commencing as soon as the heated portions 28, 30 reach the hot working temperature.

From the foregoing, it can be seen that the rectilinear dashed lines 36, 38 in FIG. 1A represent boundaries (simplified for illustrative purposes) between the heated portions 28, 30 of the workpieces 10, 18 when they are first at the hot working temperature, and the body portions 32, 34 at the same time.

In use, the first and second workpieces 10, 18 are first positioned the distance “D” apart, and the heating element(s) 27 are located therebetween, as shown in FIG. 1A. Preferably, at least the first and second heated portions 28, 30 are covered with an inert (non-oxidizing) atmosphere during heating and engagement. Those skilled in the art would be aware of suitable gases that may constitute the inert atmosphere, and suitable means for containing the inert atmosphere and holding the inert atmosphere in position. In one embodiment, the inert atmosphere may be located to at least partially cover the first and second workpieces 10, 18. It will be understood that the inert atmosphere and a container therefor are omitted from the drawings for clarity of illustration.

Next, the heating element 27 preferably is energized, to heat both the first heated portion 28 of the first workpiece 10 and the second heated portion 30 of the second workpiece 18 to the hot working temperature.

Once the heated portions 28, 30 are at the hot working temperature, the heating element 27 is removed from the gap 26.

As can be seen in FIGS. 1A and 1B, once the heated portions 28, 30 are at the hot working temperature, one or both of the first and second workpieces 10, 18 preferably are subjected to translocation motion, as indicated by arrows “A₁” and “A₂” in FIG. 1B. Due to the translocation motion, the engagement surfaces 12, 20 are engaged with each other. It will be understood that both of the workpieces may be subjected to the translocation motion, or only one of them, i.e., the first workpiece 10, or the second workpiece 18, or both, may be translocated.

While the first and second heated portions are at the hot working temperature, the first and second engagement surfaces preferably are urged together, i.e., in the directions indicated by arrows “A₁” and “A₂”.

It is also preferred that one or both of the first and second workpieces 10, 18 are subjected to an engagement motion, while the heated portions 28, 30 are at the hot working temperature, and engaged with each other and urged together (FIG. 1B). The relative engagement motion of one or both of the first and second workpieces 10, 18 is schematically indicated by arrows “B₁” and “B₂” in FIG. 1B. Such motion is possible while the heated portions are plastically deformable, i.e., while they are at the hot working temperature. Also, the engagement motion may take place because the workpieces 10, 18 fit together in a clearance fit. It will also be understood that motion in a z direction (i.e., orthogonal to the plane of the drawing) is possible.

The engagement motion may be any type of motion of one or both of the engaged first and second workpieces 10, 18 relative to the other, whether regularly repeated or not. While the first and second workpieces 10, 18 are engaged with each other, it is preferred that they are pressed against each other, i.e., upon engagement, the workpieces 10, 18 are urged together, in the opposed directions indicated by arrows “A₁” and “A₂” in FIG. 1B. After the engagement surfaces 12, 20 are engaged with each other, and the workpieces 10, 18 are subjected to the engagement motion, the workpieces 10, 18 preferably are continuously urged against each other until they are bonded together, as will be described.

In summary, while the heated portions 28, 30 are at the hot working temperature and the engagement surfaces 12, 20 are urged against each other, one or both of the workpieces 10, 18 preferably are also subjected to the engagement motion(s). The engagement motion may be any suitable movement of one or both of the workpieces 10, 18 relative to the other. The relative motion may be regularly repeated (e.g., at preselected time intervals) or irregularly repeated.

In one embodiment, and as can be seen in FIG. 1A, the first peaks 14 preferably are initially aligned with the second troughs 24, and the second peaks 22 preferably are initially aligned with the first troughs 16. As illustrated in FIG. 1B, in one embodiment, the translocation motion preferably locates the first peaks 14 in the second troughs 24, and the second peaks 22 in the first troughs 16. As can be seen in FIGS. 1A and 1B, in one embodiment, the first peaks preferably fit into the second troughs, and the second peaks preferably fit into the first troughs. Preferably, the first peaks, the first troughs, and the second troughs are rounded.

Those skilled in the art would appreciate that, in the embodiment illustrated in FIGS. 1A and 1B, upon engagement thereof, the first and second workpieces 10, 18 preferably fit together in a clearance fit, i.e., once the peaks are located in the troughs respectively, a predetermined, relatively small, clearance between the engagement surfaces 12, 20 results.

As can be seen in FIG. 1A, the peaks 14, 22 are proximal to the heating element(s) 27 during heating. Preferably, the peaks 14, 22 are formed in order to isolate, to a limited extent, the heated portions 28, 30, from the body portions 32, 34, i.e., to at least partially isolate the portions of the workpieces 10, 18 that are initially heated to the hot working temperature from the body portions 32, 34 thereof that are not initially heated to the hot working temperature. In this way, the transfer of heat by conduction from the heated portions to the balance of the workpieces is limited by the physical characteristics of the engagement surfaces 12, 20. The peaks 14, 22 are formed to limit the extent to which the volumes of the heated portions 28, 30 are contiguous with respective volumes of the body portions 32, 34, thereby limiting the extent of the heat transfer by conduction from the heated portions 28, 30 to the body portions 32, 34.

It is believed that, because the extent of heat transfer from the heated portions to the body portions is limited, after they are initially heated to the hot working temperature, the heated portions remain at the hot working temperature for a sufficiently long time to enable them to bond together due to the engagement motion, as will be described.

As noted above, in one embodiment, the workpieces 10, 18 preferably are made of one or more metals with relatively high thermal conductivity. Those skilled in the art would be aware of metals (including alloys) with relatively high thermal conductivity, e.g., aluminum. It will be understood that, as soon as the heated portions 28, 30 are heated to the hot working temperature, there is some transfer of heat energy by conduction from the heated portions to the adjacent parts of the body portions 32, 34.

As can be seen in FIGS. 1A and 1B, in one embodiment, when the first and second engagement surfaces 12, 20 are engaged with each other, the peaks 14, 22 preferably engage respective parts “T₁”, “T₂” of the body portions 32, 34 that at least partially define the troughs 16, 24. However, the peaks 14, 22 are at the hot working temperature. As noted above, upon engagement of the workpieces 10, 18 with each other, one or both of the workpieces are subjected to relative engagement motion, while the workpieces 10, 18 are urged against each other. It is believed that, upon engagement, sufficient heat is transferred by conduction from each peak 14, 22 to each respective part “T₁”, “T₂” for the material of the workpieces to bond together along the entire engagement surfaces 12, 20.

As noted above, the material is plastically deformable over a range of hot working temperatures. Because the workpieces are made of material with high thermal conductivity, heat is transferred relatively quickly from the peaks 14, 22 to the parts “T₁”, “T₂” engaged by the peaks.

It will be understood that the material in the heated portions 28, 30 that is at a hot working temperature are very thin layers, and the thicknesses of the heated portions 28, 30 as illustrated in FIGS. 1A and 1B have been exaggerated for clarity of illustration. As noted above, the engagement surfaces 12, 20 are, after engagement, at hot working temperatures for a brief time period, i.e., the layers are hot enough to be plastically deformed when they engage each other. The respective engaged heated material tend to adhere to each other, and the heated material is subjected to shearing due to the engagement motion, while they are engaged and at hot working temperatures. The shearing action tears the microstructure of the metal in the heated material, to form a region “R” of recrystallized metal spanning across the original engagement surfaces 12, 20, and the engagement surfaces are subsumed in the region “R” (FIG. 1C). In this way, the workpieces 10, 18 are metallurgically bonded together. Recrystallization of the metal takes place as the metal is sheared and cools, and the recrystallization results in a relatively uniformly fine-grained microstructure across the region “R” (FIG. 1C) at which the workpieces 10, 18 are joined or bonded together, in which the original engagement surfaces are at least partially subsumed.

The region “R” of metallurgical bonding may be somewhat smaller than the heated portions 28, 30, and may not be generally rectilinear in shape, as illustrated in FIG. 1C. It will be understood that the width of the region “R” as illustrated in FIG. 1C has been exaggerated for clarity of illustration.

Those skilled in the art would appreciate that, where the highly thermally conductive material is aluminum, an aluminum oxide layer that forms on aluminum in ambient atmosphere may have to be addressed, because the aluminum oxide layer would interfere with the metallurgical bonding. For example, the engagement surfaces 12, 20 of the first and second workpieces 10, 18 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

In accordance with the foregoing, the workpieces 10, 18 are joined or bonded together to form a product 39 (FIG. 1C). The first and second workpieces are joined together across the region “R”, and the microstructure in the region “R” is a substantially uniform relatively fine-grained microstructure, providing a strong bond.

In FIG. 1C, the product 39 is illustrated as having side profiles “P₁”, “P₂” that are planar, or substantially planar. However, it will be understood that the product 39 may be formed so that, at the region “R” where the workpieces 10, 18 are bonded together to form the product 39, the profiles “P₁”, “P₂” may be non-planar, e.g., convex or concave. As an example, a convex part “Q” is illustrated in dashed lines in FIG. 1C.

In an alternative embodiment of the method of the invention, the translocation motion may be briefly paused after the engagement surfaces are initially engaged. That is, after the initial engagement of the engagement surfaces 12, 20 with each other, for a short predetermined period, the workpieces may not be further urged together, although they are engaged with each other. The engagement motion may continue during this short predetermined period. It is believed that, during the short predetermined period, heat may be further transferred by conduction into the parts “T₁”, “T₂”, either from the heated portions respectively connected therewith, or from the heated portions that respectively engage the parts “T₁”, “T₂”. After the short predetermined period, the workpieces are again urged against each other, and the engagement motion continues, resulting in the workpieces being bonded together. Alternatively, after the short predetermined period, the engagement motion continues (or is recommenced, as the case may be) and the workpieces are subsequently urged against each other.

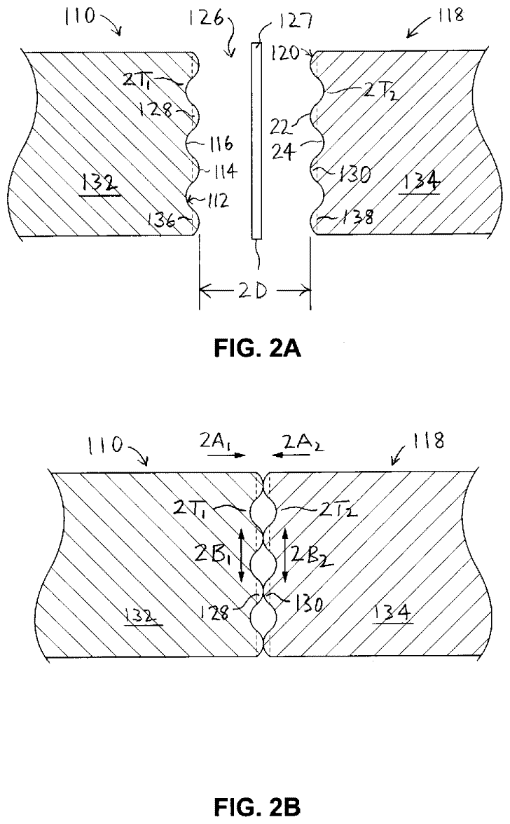

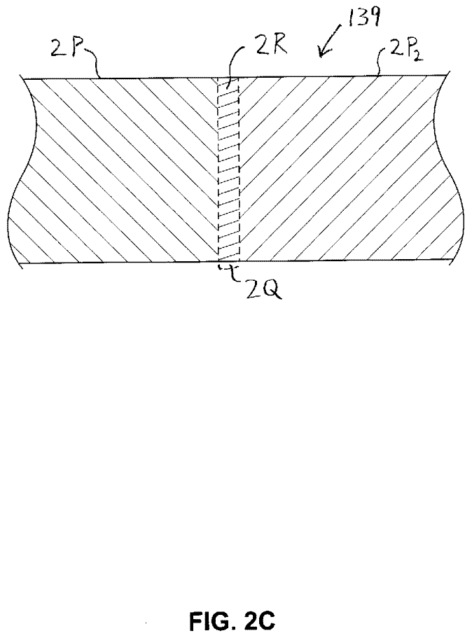

Another alternative embodiment of the method of the invention is illustrated in FIGS. 2A-2C.

As can be seen in FIGS. 2A and 2B, in this embodiment, the first and second workpieces 110, 118 preferably are positioned to align first peaks 114 of the first workpiece 110 with second peaks 122 of the second workpiece 118. Also, first troughs 116 preferably are also aligned with second troughs 124.

The first and second workpieces 110, 118 preferably are positioned a second predetermined distance “2D” apart from each other. It will be understood that the first and second workpieces 110, 118 are made of a highly thermally conductive material, e.g., aluminum. The first and second workpieces 110, 118 preferably are positioned to locate first and second engagement surfaces 112, 120 facing each other to define a gap 126 therebetween.

Next, one or more heating elements 127 preferably are positioned in the gap 126, for heating respective first and second heated portions 128, 130 respectively adjacent to the first and second engagement surfaces 112, 120 to a hot working temperature at which the first and second heated portions 128, 130 are plastically deformable. It is preferred that the heated portions 128, 130 are heated by induction heating.

Only the heated portions 128, 130 are initially heated to the hot working temperature. Upon the first and second heated portions 128, 130 being heated to the hot working temperature, respective first and second body portions 132, 134 are thereby defined in the first and second workpieces 110, 118. The first and second body portions 132, 134 are not initially heated to the hot working temperature. It will be understood that the first and second body portions 132, 134 are those parts of the first and second workpieces 110, 118 that are connected to the first and second heated portions 128, 130 that are not initially heated to the hot working temperature.

The first and second heated portions 128, 130 preferably are proximal to the first and second peaks 114, 122. The first and second peaks 114, 122 are formed to limit heat transfer therefrom by conduction into the first and second body portions 132, 134 respectively.

As can be seen in FIGS. 2A and 2B, dashed lines identified by reference characters 136, 138 respectively indicate idealized boundaries, (i) between the first heated portion 128 and the first body portion 132, and (ii) between the second heated portion 130 and the second body portion 134. As noted above, the first and second body portions 132, 134 initially are at temperatures that are less than the hot working temperature.

In use, the first and second workpieces 110, 118 are first positioned a distance “2D” apart, with the heating element(s) 127 therebetween. Preferably, the first and second engagement surfaces 112, 120 and the first and second heated portions 128, 130 are covered with an inert atmosphere during heating and engagement. Those skilled in the art would be aware of suitable gases that may provide the inert atmosphere, and suitable means for containing the inert atmosphere.

Next, the heating element 127 preferably is energized, to heat the first heated portion 128 of the first workpiece 110 and the second heated portion 130 of the second workpiece 118 to the hot working temperature.

While the first and second heated portions 128, 130 are at the hot working temperature, the first and second engagement surfaces 112, 120 are engaged with each other, to bond the first and second workpieces 110, 118 together. As can be seen in FIGS. 2A and 2B, once the heated portions 128, 130 are at the hot working temperature, one or both of the first and second workpieces 110, 118 preferably are subjected to translocation motion, as indicated by arrows “2A₁” and “2A₂” in FIG. 2B. Due to the translocation motion, the heated portions 128, 130 are engaged with each other. It will be understood that both of the workpieces may be subjected to the translocation motion, or only one of them, i.e., either the first workpiece 110, or the second workpiece 118, or both, may be subjected to the translocation motion.

As illustrated in FIG. 2B, in one embodiment, the translocation motion preferably causes the first peaks 114 to engage the second peaks 122. Once the first peaks 114 engage the second peaks 122, and the first troughs 116 are positioned opposite to the second troughs 124.

Those skilled in the art would appreciate that, in the embodiment illustrated in FIGS. 2A and 2B, upon engagement thereof, the heated portions 128, 130 on the first and second peaks 114, 122 are plastically deformed. The deformed peaks substantially fill the troughs to which the peaks are adjacent, at least partially due to engagement motion to which one or both of the workpieces 110, 118 are subjected, while the heated portions are at the hot working temperature and while the heated portions 128, 130 are pressed together. In FIG. 2C, a product formed by bonding the workpieces 110 and 118 together is identified by reference character 139.

The engagement motion may be any type of motion of one or both of the engaged first and second workpieces 110, 118 relative to the other. The relative engagement motion of one or both of the first and second workpieces 110, 118 is schematically indicated by arrows “2B₁” and “2B₂” in FIG. 2B, and such engagement motion may also include motion in a z direction, i.e., motion orthogonal to the plane of the drawing. While the first and second workpieces 110, 118 are engaged, the workpieces 110, 118 are urged against each other, in the opposite directions indicated by arrows “2A₁” and “2A₂” in FIG. 2B. After the engagement surfaces 112, 120 are engaged with each other, the workpieces 110, 118 are continuously urged against each other until they are joined together.

It will be understood that the peaks and troughs may have any suitable configurations. The peaks and troughs of the first and second workpieces 110, 118 preferably are formed to limit heat transfer by conduction from the peaks to the balance of the workpieces. Limiting the rate at which heat energy is transferred by conduction from the heated regions 128, 130 to the body portions 132, 134 enables the heated portions 128, 130 to remain at the hot working temperature for a longer time.

However, those skilled in the art would appreciate that some transfer of heat energy to parts “2T₁”, “2T₂” of the body portions 132, 134 that define the troughs 116, 124 is preferred, because the parts “2T₁”, “2T₂” are also to be heated to the hot working temperature, and plastically deformable. Preferably, the peaks 114, 122 and the troughs 116, 124 are formed to facilitate transfer of sufficient heat energy by conduction from the heated portions 128, 130 to the parts “2T₁”, “2T₂” so as to heat the parts “2T₁”, “2T₂” to the hot working temperature over a relatively short time.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 112, 120 of the first and second workpieces 110, 118 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

The heated portions 128, 130 are plastically deformed when the engage each other, and the parts “2T₁”, “2T₂” that define the troughs 116, 124 are brought into engagement with each other, once the heated portions 128, 130 are sufficiently plastically deformed. Subsequently, the workpieces 110, 118 are subjected to engagement motion, and the microstructure of the material that is engaged and at the hot working temperature is subjected to shear, as described above. As is also described above, recrystallization of the metal takes place as the metal is sheared and cools, and the recrystallization results in a relatively uniformly fine-grained microstructure across a region “2R” (FIG. 2C) at which the workpieces 110, 118 are bonded together.

The workpieces 110, 118 are joined or bonded together to form a product 139 (FIG. 2C). The first and second workpieces are joined together across the region “2R”. The microstructure in the region “2R” is a substantially uniform relatively fine-grained microstructure, providing a strong bond, and the engagement surfaces are at least partially subsumed in the region “2R”.

It will also be understood that the extent of the region “2R” as illustrated in FIG. 2C is exaggerated, for clarity of illustration.

In FIG. 2C, the product 139 is illustrated as having side profiles “2P₁”, “2P₂” that are planar, or substantially planar. However, it will be understood that the product 139 may be formed so that, at the region “2R” where the workpieces 110, 118 are bonded together, the profiles “2P₁”, “2P₂” may be non-planar, e.g., convex or concave. As an example, a convex part “2Q” is illustrated in dashed lines in FIG. 2C.

In an alternative embodiment of the method of the invention, the translocation motion may be briefly paused after the engagement surfaces are initially engaged. That is, after the initial engagement of the engagement surfaces 112, 120 with each other, for a short predetermined period, the workpieces are not further urged together, although they are engaged with each other. The engagement motion may continue during this short predetermined period. It is believed that, during the short predetermined period, heat may be further transferred by conduction into the parts “2T₁”, “2T₂”, i.e., from the heated portions respectively connected therewith. After the short predetermined period, the workpieces are again urged against each other, and the engagement motion continues, resulting in the workpieces being bonded together. Alternatively, after the short predetermined period, the engagement motion continues (or is recommenced, as the case may be) and the workpieces are subsequently urged against each other.

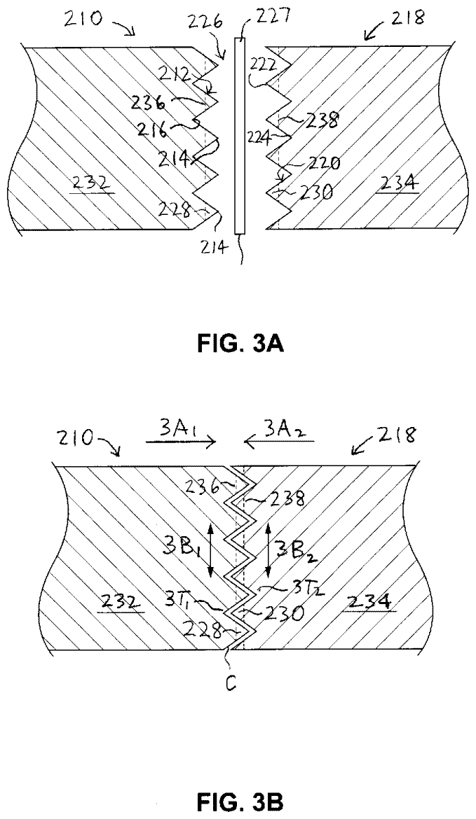

In another embodiment of the method of the invention, illustrated in FIGS. 3A and 3B, the workpieces 210, 218 include peaks 214, 222 that are pointed, and fit into complementary troughs 216, 224. It will be understood that the manner in which the workpieces 210, 218 are heated and engaged is substantially the same as in the embodiment of the method that is illustrated in FIGS. 1A-1C.

Preferably, one or more heating elements 227 are positioned in a gap 226 between the first and second engagement surfaces 212, 220, to heat the heated portions 228, 230 to a hot working temperature. It will be understood that the first and second workpieces 210, 218 are made of a highly thermally conductive material, e.g., aluminum. However, first and second body portions 232, 234 of the first and second workpieces 210, 218 preferably are not initially heated to the hot working temperature.

Preferably, prior to heating, the first and second engagement surfaces 212, 220 and the first and second heated portions 228, 230 are covered or enveloped with an inert atmosphere. The inert atmosphere preferably remains in place during heating and engagement. Those skilled in the art would be aware of suitable gases that may be the inert atmosphere, and suitable means for containing the inert atmosphere.

The workpieces 210, 218 preferably are subjected to a translocation motion, to engage first and second engagement surfaces 212, 220 thereof with each other, as indicated by arrows “3A₁”, “3A₂” (FIG. 3B), while the heated portions 228, 230 are at the hot working temperature. After engagement, the workpieces are urged against each other (in the directions indicated by arrows “3A₁”, “3A₂”) until they are bonded together. One or both of the workpieces 210, 218 are also subjected to an engagement motion while the heated portions 228, 230 are at the hot working temperature, so that at least one of the workpieces is moved relative to the other, as indicated by arrows “3B₁”, “3B₂”. Because the peaks and troughs are interlocked, as shown in FIG. 3B, the extent to which engagement motion of one workpiece to the other in the directions indicated by arrows “3B₁”, “3B₂” is possible is limited to the clearance between the workpieces. It will be understood that the engagement motion may also take place relative to the z direction, i.e., orthogonal to the plane of the drawing. In FIG. 3B, the clearance “C” is exaggerated for clarity of illustration.

As can be seen in FIGS. 3A and 3B, dashed lines identified by reference characters 236, 238 respectively indicate idealized boundaries, (i) between the first heated portion 228 and the first body portion 232, and (ii) between the second heated portion 230 and the second body portion 234. As noted above, the first and second body portions 232, 234 initially are at temperatures that are less than the hot working temperature.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 212, 220 of the first and second workpieces 210, 218 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

As can be seen in FIG. 3A, the peaks 214, 222 are proximal to the heating element(s) 227 during heating. Preferably, the peaks 214, 222 are formed in order to isolate, to a limited extent, the heated portions 228, 230, from the body portions 232, 234, i.e., to at least partially isolate the portions of the workpieces 210, 218 that are initially heated to the hot working temperature from the portions thereof that are not initially heated to the hot working temperature. In this way, the transfer of heat by conduction from the heated portions to the balance of the workpieces is limited. The peaks 214, 222 are formed to limit the extent to which the volumes of the heated portions 228, 230 are contiguous with respective volumes of the body portions 232, 234, thereby limiting the extent of the heat transfer by conduction from the heated portions 228, 230 to the body portions 232, 234.

Because the extent of heat transfer from the heated portions to the body portions is limited, after they are initially heated to the hot working temperature, the heated portions remain at the hot working temperature for a sufficiently long time to enable them to bond together due to the engagement motion, as will be described.

As can be seen in FIGS. 3A and 3B, when the first and second engagement surfaces 212, 220 are engaged with each other, the peaks 214, 222 engage respective parts “3T₁”, “3T₂” of the body portions 232, 234 that define the troughs 216, 224. However, the peaks 214, 222 are at the hot working temperature. As noted above, upon engagement of the workpieces 210, 218 with each other, one or both of the workpieces are subjected to relative engagement motion, while the workpieces 210, 218 are urged against each other. It is believed that, upon engagement, sufficient heat is transferred by conduction from each peak 214, 222 to each respective part “3T₁”, “3T₂” for the material of the workpieces to bond together along the entire engagement surfaces 212, 220.

As noted above, the material is plastically deformable over a range of hot working temperatures. Because the workpieces are made of material with high thermal conductivity, heat is transferred relatively quickly from the peaks 214, 222 to the parts “3T₁”, “3T₂” engaged by the peaks.

In an alternative embodiment of the method of the invention, the translocation motion may be briefly paused after the engagement surfaces are initially engaged. That is, after the initial engagement of the engagement surfaces 212, 220 with each other, for a short predetermined period, the workpieces are not further urged together, although they are engaged with each other. The engagement motion may continue during this short predetermined period. It is believed that, during the short predetermined period, heat may be further transferred by conduction into the parts “3T₁”, “3T₂”, either from the heated portions respectively connected therewith, or from the heated portions that respectively engage the parts “3T₁”, “3T₂”. After the short predetermined period, the workpieces are again urged against each other, and the engagement motion continues, resulting in the workpieces being bonded together. Alternatively, after the short predetermined period, the engagement motion continues (or is recommenced, as the case may be) and the workpieces are subsequently urged against each other.

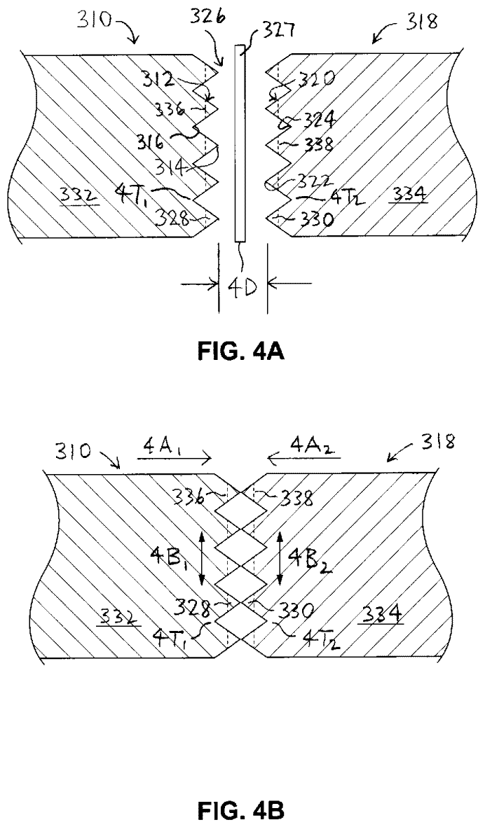

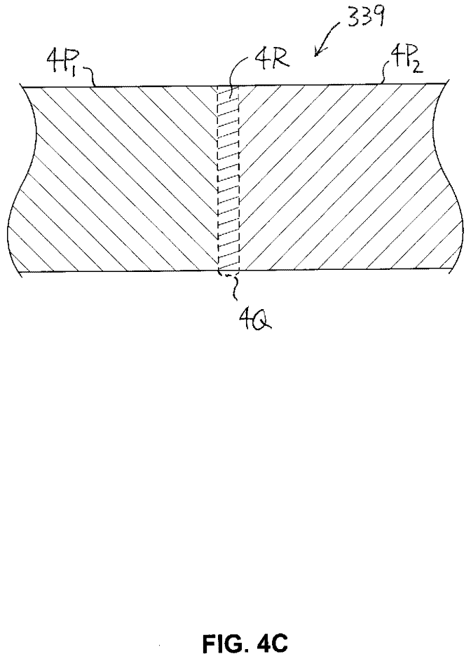

Similarly, the workpieces 310, 318 that are illustrated in FIGS. 4A-4C are heated and engaged in substantially the same manner as are the workpieces 110, 118 that are illustrated in FIGS. 2A-2C.

As can be seen in FIGS. 4A and 4B, in this embodiment, the first and second workpieces 310, 318 preferably are positioned to align first peaks 314 of the first workpiece 310 with second peaks 322 of the second workpiece 318. Therefore, first troughs 316 preferably are also aligned with second troughs 324.

The first and second workpieces 310, 318 preferably are positioned a predetermined distance “4D” apart from each other. It will be understood that the first and second workpieces 310, 318 are made of a highly thermally conductive material, e.g., aluminum. The first and second workpieces 310, 318 preferably are positioned to locate first and second engagement surfaces 312, 320 facing each other to define a gap 326 therebetween.

Next, one or more heating elements 327 preferably are positioned in the gap 326, for heating respective first and second heated portions 328, 330 respectively adjacent to the first and second engagement surfaces 312, 320 to a hot working temperature at which the first and second heated portions 328, 330 are plastically deformable. It is preferred that the heated portions 328, 330 are heated by induction heating.

Only the heated portions 328, 330 are initially heated to the hot working temperature. Upon the first and second heated portions 328, 330 being heated to the hot working temperature, respective first and second body portions 332, 334 are thereby defined in the first and second workpieces 310, 318. The first and second body portions 332, 334 are not initially heated to the hot working temperature. It will be understood that the first and second body portions 332, 334 are those parts of the first and second workpieces 310, 318 that are contiguous to the first and second heated portions 328, 330 that are not initially heated to the hot working temperature.

The first and second heated portions 328, 330 preferably are proximal to the first and second peaks 314, 322. The first and second peaks 314, 322 are formed to limit heat transfer therefrom into the first and second body portions 332, 334 respectively.

As can be seen in FIGS. 4A and 4B, dashed lines identified by reference characters 336, 338 respectively indicate idealized boundaries, (i) between the first heated portion 328 and the first body portion 332, and (ii) between the second heated portion 330 and the second body portion 334. As noted above, the first and second body portions 332, 334 initially are at temperatures that are less than the hot working temperature.

In use, the first and second workpieces 310, 318 are first positioned the distance “4D” apart, with the heating element(s) 327 therebetween. Preferably, the first and second engagement surfaces 312, 320 and the first and second heated portions 328, 330 are covered or enveloped with an inert atmosphere during heating and engagement. Those skilled in the art would be aware of suitable gases that may provide the inert atmosphere, and suitable means for containing the inert atmosphere.

Next, the heating element 327 preferably is energized, to heat both the first heated portion 328 of the first workpiece 310 and the second heated portion 330 of the second workpiece 318 to the hot working temperature.

When the first and second heated portions 328, 330 are at the hot working temperature, the first and second engagement surfaces 312, 320 are engaged with each other, to bond the first and second workpieces 310, 318 together. As can be seen in FIGS. 4A and 4B, once the heated portions 328, 330 are at the hot working temperature, one or both of the first and second workpieces 310, 318 preferably are subjected to translocation motion, as indicated by arrows “4A₁” and “4A₂” in FIG. 2B. Due to the translocation motion, the heated portions 328, 330 are engaged with each other. It will be understood that both of the workpieces may be subjected to the translocation motion, or only one of them, i.e., either the first workpiece 310, or the second workpiece 318, or both, may be subjected to the translocation motion.

Those skilled in the art would appreciate that, in the embodiment illustrated in FIGS. 4A and 4B, upon engagement thereof, the heated portions 328, 330 on the first and second peaks 314, 322 are plastically deformed. The deformed peaks substantially fill the troughs to which the peaks are adjacent, due to engagement motion to which one or both of the workpieces 310, 318 are subjected, while the heated portions are at the hot working temperature and while the heated portions 328, 330 are pressed together. In FIG. 4C, a workpiece formed by bonding the workpieces 310 and 318 together is identified by reference character 339.

The engagement motion may be any type of motion of one or both of the engaged first and second workpieces 310, 318 relative to the other. The relative engagement motion of one or both of the first and second workpieces 310, 318 is schematically indicated by arrows “4B₁” and “4B₂” in FIG. 4B, and such engagement motion may also include motion in a z direction, i.e., motion orthogonal to the plane of the drawing. While the first and second workpieces 310, 318 are engaged, the workpieces 310, 318 are urged against each other, in the opposite directions indicated by arrows “4A₁” and “4A₂” in FIG. 4B. In one embodiment, after the engagement surfaces 312, 320 are engaged with each other, the workpieces 310, 318 preferably are continuously urged against each other until they are bonded together.

It will be understood that the peaks and troughs may have any suitable configurations. The peaks and troughs of the first and second workpieces 310, 318 preferably are formed to limit heat transfer by conduction from the peaks to the balance of the respective workpieces. Limiting the rate at which heat energy is transferred by conduction from the heated regions 328, 330 to the body portions 332, 334 enables the heated portions 328, 330 to remain at the hot working temperature for a longer time.

However, those skilled in the art would appreciate that some transfer of heat energy to parts “4T₁”, “4T₂” of the respective body portions 332, 334 that define the troughs 316, 324 respectively is preferred, because the parts “4T₁”, “4T₂” are also to be heated to the hot working temperature, and plastically deformable. Preferably, the peaks 314, 322 and the troughs 316, 324 are formed to facilitate transfer of sufficient heat energy by conduction from the heated portions 328, 330 to the parts “4T₁”, “4T₂” so as to heat the parts “4T₁”, “4T₂” to the hot working temperature over a relatively short time.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 312, 320 of the first and second workpieces 310, 318 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

The heated portions 328, 330 are plastically deformed when the engage each other, and the parts “4T₁”, “4T₂” that define the troughs 316, 324 are brought into engagement with each other, once the heated portions 328, 330 are sufficiently plastically deformed. Subsequently, the workpieces 310, 318 are subjected to engagement motion, and the microstructure of the material that is engaged and at the hot working temperature is subjected to shear, as described above. As is also described above, recrystallization of the metal takes place as the metal is sheared and cools, and the recrystallization results in a relatively uniformly fine-grained microstructure across a region “4R” (FIG. 4C) at which the workpieces 310, 318 are bonded together.

The workpieces 310, 318 are joined or bonded together to form a product 339 (FIG. 4C). The first and second workpieces are joined or bonded together across the region “4R”. The microstructure in the region “4R” is a substantially uniform relatively fine-grained microstructure, providing a strong bond, and the engagement surfaces are at least partially subsumed in the region “4R”.

It will also be understood that the extent of the region “4R” as illustrated in FIG. 4C is exaggerated, for clarity of illustration.

In FIG. 4C, the product 339 is illustrated as having side profiles “4P₁”, “4P₂” that are planar, or substantially planar. However, it will be understood that the product 339 may be formed so that, at the region “4R” where the workpieces 310, 318 are bonded together, the profiles “4P₁”, “4P₂” may be non-planar, e.g., convex or concave. As an example, a convex part “4Q” is illustrated in dashed lines in FIG. 4C.

In an alternative embodiment of the method of the invention, the translocation motion may be briefly paused after the engagement surfaces are initially engaged. That is, after the initial engagement of the engagement surfaces 312, 320 with each other, for a short predetermined period, the workpieces are not further urged together, although they are engaged with each other. The engagement motion may continue during this short predetermined period. It is believed that, during the short predetermined period, heat may be further transferred by conduction into the parts “4T₁”, “4T₂”, i.e., from the heated portions respectively connected therewith. After the short predetermined period, the workpieces are again urged against each other, and the engagement motion continues, resulting in the workpieces being bonded together. Alternatively, after the short predetermined period, the engagement motion continues (or is recommenced, as the case may be) and the workpieces are subsequently urged against each other.

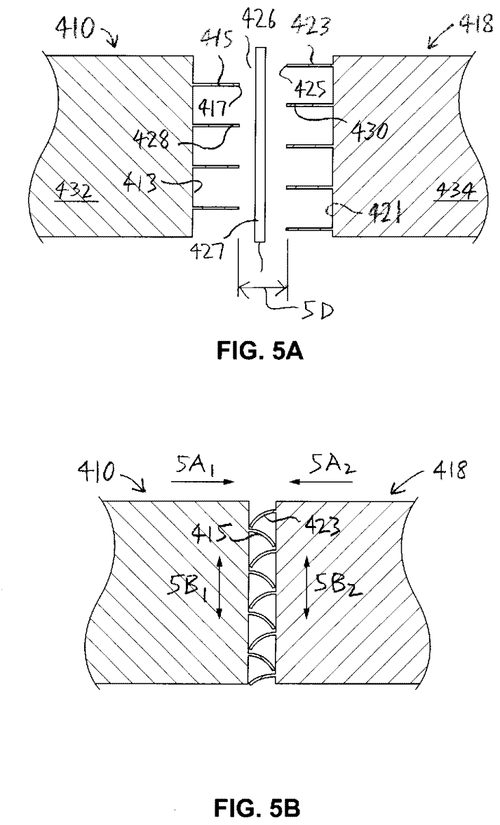

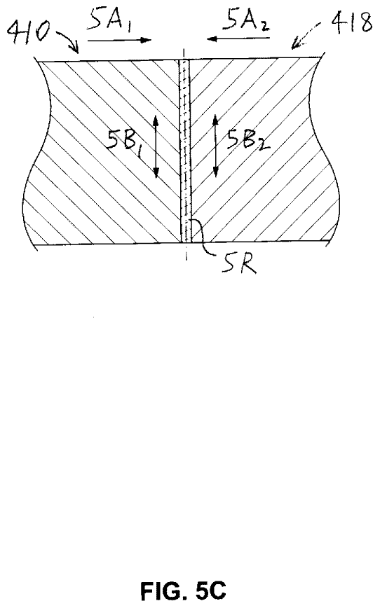

In another embodiment of the method of the invention, illustrated in FIGS. 5A-5C, the first and second workpieces 410, 418 include fins 415, 423 extending from respective exposed surfaces 413, 421 of the first and second body portions 432, 434. The fins 415, 423 terminate at respective ends 417, 425 thereof. The first and second workpieces 410, 418 preferably are positioned a distance “5D” apart, to define a gap 426 between the first and second workpieces 410, 418. It will be understood that, in one embodiment, the first and second workpieces 410, 418 are made of a highly thermally conductive material, e.g., aluminum.

Preferably, one or more heating elements 427 are positioned in the gap 426, to heat heated portions 428, 430 of the workpieces 410, 418 to a hot working temperature, at which the heated portions 428, 430 are plastically deformable. The heating elements 427 preferably heat the heated portions 428, 430 by induction heating.

It will be understood that the fins 415, 423 are relatively thin, e.g., approximately 0.1 mm thick, or less. In one embodiment, the heated portions 428, 430 extend from the respective ends 417, 425 of the fins 415, 423 toward the exposed surfaces 413, 421 of the respective body portions 432, 434. Preferably, the first and second heated portions are at least partially distal to the exposed surfaces. However, it will also be understood that the heated portions 428, 430 may include parts of the bodies 432, 434.

The fins 415, 423 are relatively thin in order to limit the extent to which heat may be conducted therethrough from the heated portions 428, 430 to the body portions 432, 434 respectively. First and second body portions 432, 434 of the first and second workpieces 410, 418 preferably are not heated to the hot working temperature.

Preferably, at least the first and second heated portions are covered or enveloped with an inert atmosphere during heating and engagement. Those skilled in the art would be aware of suitable gases that may provide the inert atmosphere, and suitable means for containing the inert atmosphere.

The workpieces 410, 418 preferably are subjected to a translocation motion while the heated portions 428, 430 are at the hot working temperature, as indicated by arrows “5A₁”, “5A₂” in FIGS. 5B and 5C, to engage the fins 415 of the first workpiece 410 and the fins 423 of the second workpiece 418 together.

After initial engagement, the workpieces 410, 418 are continuously urged against each other (i.e., in the directions indicated by arrows “5A₁”, “5A₂”) until they are bonded together. One or both of the workpieces 410, 418 are also subjected to an engagement motion while the heated portions 428, 430 are at the hot working temperature, so that at least one of the workpieces is moved relative to the other, as indicated by arrows “5B₁”, “5B₂” in FIGS. 5B and 5C.

As can be seen in FIG. 5B, upon initial engagement, the fins 415, 423 are bent, and the heated portions 428, 430 tend to be engaged with the opposite exposed surface of the body portions 432, 434. For example, it can be seen in FIG. 5B that the heated portion 428 of the fin 415 of the first workpiece 410 may be engaged with the exposed surface 421 of the body portion 434 of the second workpiece 418. Similarly, the heated portion 430 of the fin 423 of the second workpiece 418 may be engaged with the exposed surface 413 of the first body portion 432 of the first workpiece 410. As noted above, the first and second body portions 432, 434 preferably are at temperatures that are less than the hot working temperature.

After the initial engagement of the first and second workpieces 410, 418, the translocation motion and the engagement motion continue, until the first and second workpieces 410, 418 are bonded to each other, as illustrated in FIG. 5C. It will be understood that the heated portions 428, 430 are plastically deformable when they are at the hot working temperature. Accordingly, and as shown in FIG. 5C, the continued engagement motion of the first and/or second workpiece 410, 418 relative to each other and the continued urging of the workpieces 410, 418 together presses the fins 415, 423 together in the region between the exposed surfaces 413, 421 of the first and second workpieces 410, 418. The at least partially plastically deformed fins that are pressed between the exposed surfaces 413, 421, and possibly also parts of the bodies 432, 434, form a region that is identified in FIG. 5C by reference character “5R”, for clarity of illustration.

Because of the continuing engagement motion, and because the first and second workpieces are urged together, the material in the region “5R” is subjected to shear, to provide the material in the region “5R” a relatively uniform microstructure across the region “5R”, in which the exposed surfaces and the fins are subsumed, to metallurgically bond or join the first and second workpieces 410, 418 together.

In practice, where the highly thermally conductive material is aluminum, an aluminum oxide layer that forms on aluminum in ambient atmosphere may have to be addressed, because the aluminum oxide layer may interfere with bonding. For example, the fins 415, 423 and the exposed surfaces 413, 421 of the first and second workpieces 410, 418 may be formed (e.g., by cutting and grinding) shortly before they are enveloped or covered by the inert atmosphere. Alternatively, the oxide layer may be sufficiently broken up when the engaged materials are subjected to shear, in the absence of cutting or grinding the engagement surfaces.

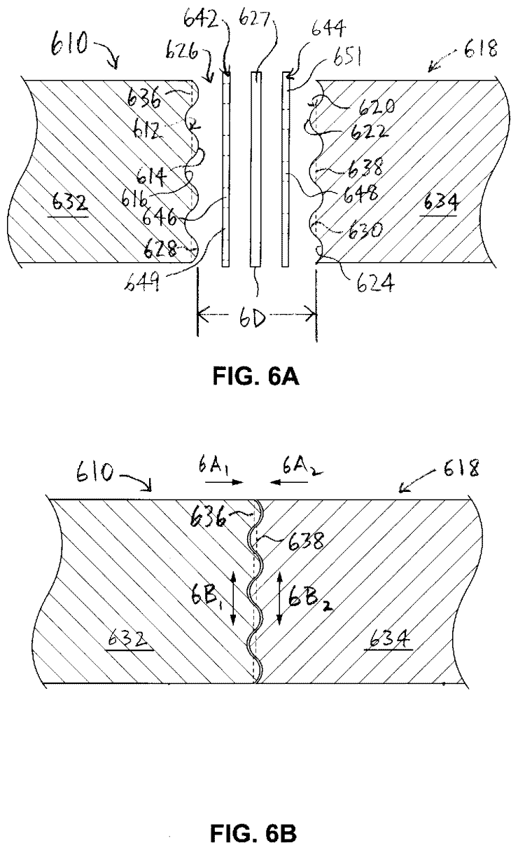

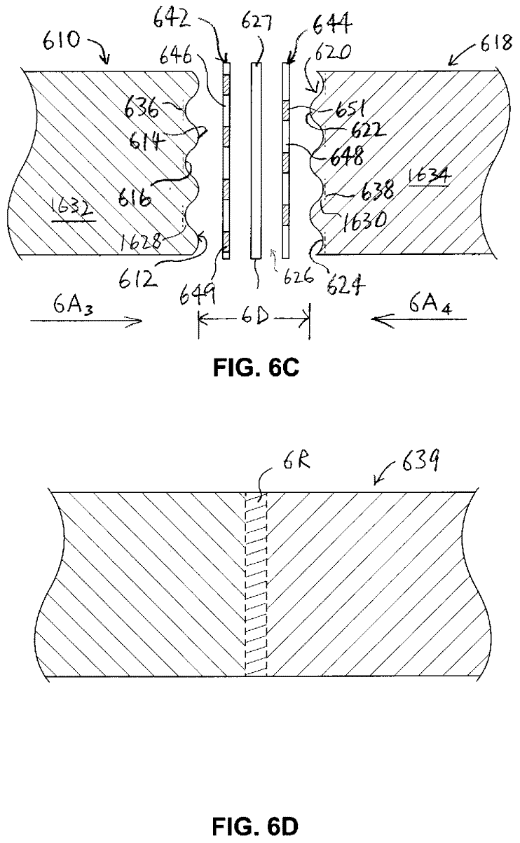

As can be seen in FIGS. 6A and 6B, in one embodiment, the method includes providing a first workpiece 610 has a first engagement surface 612. A second workpiece 618, also having a second engagement surface 620, is also provided. In one embodiment, the workpieces may include materials (e.g., metals) that are highly thermally conductive.

Preferably, the first and second workpieces 610, 618 are positioned a predetermined distance “6D” apart from each other to locate the first and second engagement surfaces 612, 620 facing each other to define a gap 626 therebetween (FIG. 6A).

One or more heating elements 627 are positioned in the gap 626, for heating respective first and second heated portions 628, 630 adjacent to the first and second engagement surfaces 612, 620 at first and second peaks 614, 622 to respective first and second hot working temperatures at which the first and second heated portions 628, 630 are subject to plastic deformation.

Next, at least the first and second heated portions 628, 630 preferably are covered with an inert atmosphere. Those skilled in the art would appreciate that the inert atmosphere preferably is contained within a suitable container (not shown).

Preferably, one or more heat shield elements are positioned between the heating element 627 and the first engagement surface 612, for moderating the extent to which the first heated portion 628 is heated, i.e., to limit the rate of heat transfer from the heated portion 628 to the body portion 632.

In the embodiment illustrated in FIG. 6A, two heat shield elements 642, 644 are illustrated. As shown in FIG. 6A, the first heat shield element 642 is positioned between the heating element 627 and the first engagement surface 612. The second heat shield element 644 is positioned between the heating element 627 and the second engagement surface 620. The second heat shield element 644 is configured for moderating the extent to which the second heated portion 630 is heated.

In one embodiment, the first and second heat shields 642, 644 preferably include respective first and second openings or slots 646, 648. Preferably, the heat shields are positioned to locate the openings 646, 648 in alignment with the first and second peaks 614, 622 respectively, i.e., opposed to the peaks. As a result, the first and second peaks 614, 622 are heated by the heating element 627 (e.g., by induction), while the troughs 616, 624 are heated to a lesser extent, due to the body 649, 651 of the first and second heat shield elements 642, 644 being located between the heating element 627 and the troughs 616, 624 respectively.

It is preferred that the heating element 627 heats the heated portions 628, 630 by induction. Accordingly, the heat shield elements 642, 644 preferably are configured for moderating the extent to which the first and second heated portions 628, 630 are heated, preferably by induction heating via the heating element 627.

In FIG. 6A, only one heating element 627 is shown, for clarity of illustration. As can be seen in FIG. 6A, when the heating element 627 is positioned in the gap 626, the heating element 627 defines first and second slots (i) between the heating element 627 and the first engagement surface 612, and (ii) between the heating element 627 and the second engagement surface 620, in which the first and second heat shield elements 642, 644 preferably are located.

It will be understood that, depending on the circumstances, only one of the heat shield elements 642, 644 may be utilized.

Due to the heat shield elements 642, 644, the heated portions 628, 630 of the first and second workpieces 610, 618 may be heated to different respective hot working temperatures. However, those skilled in the art would appreciate that, alternatively, the first and second heated portions 628, 630 may be heated to the same, or approximately the same, hot working temperature.

Preferably, the heating element 627 is energized, to heat the first heated portion 628 of the first workpiece 610 and the second heated portion 630 of the second workpiece 618 to respective first and second hot working temperatures.

The first and second heated portions 628, 630 preferably are proximal to the first and second peaks 614, 622. The first and second peaks 614, 622 are formed to limit heat transfer therefrom into the first and second body portions 632, 634 respectively.

For clarity of illustration, in FIGS. 6A and 6C, dashed lines identified by reference characters 636, 638 respectively indicate idealized boundaries, (i) between the first heated portion 628 and the first body portion 632, and (ii) between the second heated portion 630 and the second body portion 634. As noted above, the first and second body portions 632, 634 are at temperatures that are less than the hot working temperature.

Accordingly, the dashed lines 636, 638 represent points on the workpieces at which the temperature of the workpieces 610, 618 are less than the hot working temperature. Those skilled in the art would appreciate that the boundaries 636, 638 as illustrated are approximate, because they are represented as rectilinear lines, although they may not be so in fact. Those skilled in the art would also appreciate that, in practice, the location of a boundary between a heated portion and the body portion contiguous thereto may vary, over a short time period, as heat is transferred from the heated portion to the body portion. From the foregoing, it can be seen that the rectilinear dashed lines 636, 638 represent boundaries between the portions 628, 630 of the workpieces 610, 618 that are at the hot working temperature, and the portions 632, 634 that are at a temperature that is less than the hot working temperature, that are simplified for illustrative purposes.

When the first and second heated portions 628, 630 are plastically deformable, the first and second engagement surfaces 612, 620 are engaged with each other, and one or more of the engagement surfaces is moved relative to the other, to bond the first and second workpieces 610, 618 together. It will be understood that the heating element 627 and the heat shield elements 642, 644 preferably are removed before the first and second engagement surfaces 612, 620 are engaged with each other.

As can be seen in FIG. 6B, in one embodiment, the first and second workpieces 610, 618 preferably are subjected to a translocation motion while the heated portions are at the hot working temperature, in the directions indicated by arrows “6A₁” and “6A₂”. As a result, the first and second engagement surfaces 612, 620 are then engaged with each other. In FIGS. 6A and 6B, it can be seen that the first peaks 614 preferably are aligned with second troughs 624 before engagement. Similarly, before engagement, the second peaks 622 preferably are aligned with first troughs 616.

As illustrated in FIG. 6B, in one embodiment, the translocation motion preferably locates the first peaks 614 in the second troughs 624, and the second peaks 622 in the first troughs 616. Those skilled in the art would appreciate that, in the embodiment illustrated in FIGS. 6A and 6B, upon engagement of the first and second engagement surfaces 612, 620, the first and second workpieces 610, 618 preferably fit together in a clearance fit, i.e., once the peaks are located in the troughs respectively, a predetermined clearance between the first and second engagement surfaces 612, 620 results.

It is also preferred that at least one of the first and second workpieces 610, 618, or both of the first and second workpieces 610, 618, are subjected to engagement motions, while the heated portions 628, 630 are at the hot working temperature, and engaged with each other and urged together (FIG. 6B). Such motion is possible because the workpieces 610, 618 fit together in a clearance fit. It will be understood that the engagement motion may be any type of motion of one or both of the engaged first and second workpieces 610, 618 relative to the other, subject to the constraint that the engagement motion is limited by the clearance. The relative engagement motion of one or both of the first and second workpieces 610, 618 is schematically indicated by arrows “6B₁” and “6B₂” in FIG. 6B. While the first and second workpieces 610, 618 are subject to the engagement motion, it is preferred that they are pressed against each other, i.e., upon engagement, the workpieces 610, 618 are urged against each other, in the opposed directions indicated by arrows “6A₁” and “6A₂” in FIG. 6B. After the engagement surfaces 612, 620 are engaged with each other, the workpieces 610, 618 are continuously urged against each other until they are joined or bonded together.

It will be understood that, while the heated portions 628, 630 are at the hot working temperature and the engagement surfaces 612, 620 are urged against each other, one or both of the workpieces 610, 618 preferably are also subjected to the engagement motion(s). The engagement motion may be any suitable movement of one or both of the workpieces 610, 618 relative to the other. The relative motion may be regularly repeated (e.g., at preselected time intervals) or irregularly repeated.

For example, one or both of the workpieces 610, 618 may move relative to the other in the same plane, as generally indicated by arrows “6B₁” and “6B₂” in FIG. 6B. It will be understood that, in the embodiment illustrated in FIGS. 6A and 6B, any such movement is of necessity limited by the predetermined clearance.

As can be seen in FIG. 6A, the peaks 614, 622 are formed to be proximal to the heating element(s) 627 during heating, although the heat shield elements 642, 644 preferably are located between the peaks 614, 622 and the heating element(s) 627. The peaks 614, 622 are formed in order to isolate, to a limited extent, the heated portions 628, 630, from the body portions 632, 634, i.e., to at least partially isolate the portions of the workpieces 610, 618 that are heated to the hot working temperature from the portions thereof that are not heated to the hot working temperature. From the foregoing, it can be seen that the engagement surfaces 612, 620 are formed to limit the extent to which the volumes of the heated portions 628, 630 are contiguous with respective volumes of the body portions 632, 634, thereby limiting the extent of the heat transfer from the heated portions 628, 630 to the body portions 632, 634.

As can be seen in FIG. 6B, when the first and second engagement surfaces 612, 620 are engaged with each other, at the engagement surfaces in the troughs 616, 624, the workpieces 610, 618 are not at the hot working temperature. However, the peaks 614, 622 are at the hot working temperature. As noted above, upon engagement of the workpieces 610, 618 with each other, one or both of the workpieces are subjected to relative (engagement) motion, to a limited extent. It is believed that sufficient heat is transferred via the engagement surfaces 612, 620 from each peak to each respective trough for the material of the workpieces to bond together along the entire engagement surfaces 612, 620.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 612, 620 of the first and second workpieces 610, 618 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

As described above, at least parts of the heated portions are plastically deformed and sheared during the engagement motions, to form a region (not shown in FIG. 6B) with a substantially uniform microstructure in which the engagement surfaces are subsumed, to metallurgically bond or join the workpieces together.

In an alternative embodiment, the heat shield element 642, 644 may be positioned between the workpieces 610, 618 to locate the openings 646, 648 opposed to the first and second troughs 616, 624 (FIGS. 6C, 6D). For clarity of illustration, the first and second heated portions are identified in FIG. 6C by reference characters 1628, 1630, and the first and second body portions are identified by reference characters 1632, 1634.

Preferably, the first and second workpieces 610, 618 are positioned a predetermined distance “6D” apart from each other to locate the first and second engagement surfaces 612, 620 facing each other to define a gap 626 therebetween (FIG. 6C).

One or more heating elements 627 are positioned in the gap 626, for heating the respective first and second heated portions 1628, 1630 adjacent to the first and second engagement surfaces 612, 620 at first and second troughs 616, 624 to respective first and second hot working temperatures at which the first and second heated portions 1628, 1630 are subject to plastic deformation.

Next, at least the first and second heated portions 1628, 1630 preferably are covered with an inert atmosphere. Those skilled in the art would appreciate that the inert atmosphere preferably is contained within a suitable container (not shown).

Preferably, one or more heat shield elements are positioned between the heating element 627 and the first engagement surface 612, for moderating the extent to which the first heated portion 1628 is heated, i.e., to limit the rate of heat transfer from the first heated portion 1628 to the first body portion 1632.

In the embodiment illustrated in FIG. 6C, two heat shield elements 642, 644 are illustrated. As shown in FIG. 6C, the first heat shield element 642 is positioned between the heating element 627 and the first engagement surface 612. The second heat shield element 644 is positioned between the heating element 627 and the second engagement surface 620. The second heat shield element 644 is configured for moderating the extent to which the second heated portion 1630 is heated, i.e., to limit the rate of heat transfer from the second heated portion 1630 to the second body portion 1634.

In one embodiment, the first and second heat shields 642, 644 preferably include respective first and second openings or slots 646, 648. Preferably, the heat shields are positioned to locate the openings 646, 648 in alignment with the first and second troughs 616, 624 respectively, i.e., opposed to the troughs. As a result, the first and second troughs 616, 624 are heated by the heating element 627 (e.g., by induction), while the peaks 614, 622 are heated to a lesser extent, due to the body 649, 651 of the first and second heat shield elements 642, 644 being located between the heating element 627 and the peaks 614, 622 respectively.

It is preferred that the heating element 627 heats the heated portions 1628, 1630 by induction. Accordingly, the heat shield elements 642, 644 preferably are configured for moderating the extent to which the first and second heated portions 1628, 1630 are heated, preferably by induction heating via the heating element 627.

In FIG. 6C, only one heating element 627 is shown, for clarity of illustration. As can be seen in FIG. 6C, when the heating element 627 is positioned in the gap 626, the heating element 627 defines first and second slots (i) between the heating element 627 and the first engagement surface 612, and (ii) between the heating element 627 and the second engagement surface 620, in which the first and second heat shield elements 642, 644 preferably are located.

It will be understood that, depending on the circumstances, only one of the heat shield elements 642, 644 may be utilized.

At least the heated portions of the first and second workpieces are covered by an inert atmosphere (not shown).

Due to the heat shield elements 642, 644, the heated portions 1628, 1630 of the first and second workpieces 610, 618 may be heated to different respective hot working temperatures. However, those skilled in the art would appreciate that, alternatively, the first and second heated portions 1628, 1630 may be heated to the same, or approximately the same, hot working temperature.

Preferably, the heating element 627 is energized, to heat the first heated portion 1628 of the first workpiece 610 and the second heated portion 1630 of the second workpiece 618 to respective first and second hot working temperatures.

For clarity of illustration, in FIGS. 6A and 6C, dashed lines identified by reference characters 636, 638 respectively indicate idealized boundaries, (i) between the first heated portion 1628 and the first body portion 1632, and (ii) between the second heated portion 1630 and the second body portion 1634. As noted above, the first and second body portions 1632, 1634 are at temperatures that are less than the hot working temperature.

Accordingly, the dashed lines 636, 638 represent points on the workpieces at which the temperature of the workpieces 610, 618 are less than the hot working temperature. Those skilled in the art would appreciate that the boundaries 636, 638 as illustrated are approximate, because they are represented as rectilinear lines, although they may not be so in fact. Those skilled in the art would also appreciate that, in practice, the location of a boundary between a heated portion and the body portion contiguous thereto may vary, over a short time period, as heat is transferred from the heated portion to the body portion. From the foregoing, it can be seen that the rectilinear dashed lines 636, 638 represent boundaries between the portions 1628, 1630 of the workpieces 610, 618 that are at the hot working temperature, and the portions 1632, 1634 that are at a temperature that is less than the hot working temperature, that are simplified for illustrative purposes.

When the first and second heated portions 1628, 1630 are plastically deformable, the first and second engagement surfaces 612, 620 are engaged with each other, and one or more of the engagement surfaces is moved relative to the other, to bond the first and second workpieces 610, 618 together. It will be understood that the heating element 627 and the heat shield elements 642, 644 preferably are removed before the first and second engagement surfaces 612, 620 are engaged with each other.

In one embodiment, the first and second workpieces 610, 618 preferably are subjected to a translocation motion while the heated portions are at the hot working temperature, in the directions indicated by arrows “6A₃” and “6A₄”. As a result, the first and second engagement surfaces 612, 620 are then engaged with each other.

It is also preferred that at least one of the first and second workpieces 610, 618, or both of the first and second workpieces 610, 618, are subjected to engagement motions, while the heated portions 1628, 1630 are at the hot working temperature, and engaged with each other and urged together. It will be understood that the engagement motion may be any type of motion of one or both of the engaged first and second workpieces 610, 618 relative to the other. While the first and second workpieces 610, 618 are subject to the engagement motion, it is preferred that they are pressed against each other, i.e., upon engagement, the workpieces 610, 618 are urged against each other, in the opposed directions indicated by arrows “6A₃” and “6A₄” in FIG. 6C. After the engagement surfaces 612, 620 are engaged with each other, the workpieces 610, 618 are continuously urged against each other until they are joined or bonded together.

It is believed that, because the troughs 616, 624 are located further away from the heating element 627 than the peaks 614, 622, heating the heated portions 1628, 1630, which are adjacent to the troughs 616, 624, may require exposure to the energized heating element 627 for a longer time period. Those skilled in the art would appreciate that the arrangement illustrated in FIG. 6C may be advantageous, for example, where it is sought to delay the transfer of heat energy from the heated portions 1628, 1630 to the body portions 632, 634. For example, if the material in the workpieces 610, 618 is highly thermally conductive, then limiting (i.e., slowing) heat transfer from the heated portions 1628, 1630 to the body portions 1632, 1634 may be advantageous. Also, where the workpieces are made of materials with different thermal conductivities, the heat shields may be positioned differently relative to the respective workpieces, e.g., to slow the rate of heat transfer in the workpiece with highly thermally conductive material. In these circumstances, the heating element 627 may also be located other than equidistant from the workpieces, to limit the rate of heat transfer in one workpiece.

When engaged, the respective engaged heated portions 1628, 1630 tend to adhere to each other, and the heated material is subjected to shearing due to the engagement motion, while they are engaged and at hot working temperatures. The shearing action tears the microstructure of the metal in the heated material, to form a region “6R” of recrystallized metal spanning across the original engagement surfaces 612, 620, and the engagement surfaces are subsumed in the region “6R” (FIG. 6D). In this way, the workpieces 610, 618 are metallurgically bonded together. Recrystallization of the metal takes place as the metal is sheared and cools, and the recrystallization results in a relatively uniformly fine-grained microstructure across the region “6R” (FIG. 6D) at which the workpieces 610, 618 are joined or bonded together, in which the original engagement surfaces are at least partially subsumed.

The region “6R” of metallurgical bonding may be somewhat smaller than the heated portions 1628, 1630, and may not be generally rectilinear in shape, as illustrated in FIG. 6D. It will be understood that the width of the region “6R” as illustrated in FIG. 6D has been exaggerated for clarity of illustration.

In accordance with the foregoing, the workpieces 610, 618 are joined or bonded together to form a product 639 (FIG. 6D). The first and second workpieces are joined together across the region “6R”, and the microstructure in the region “6R” is a substantially uniform relatively fine-grained microstructure, providing a strong bond.

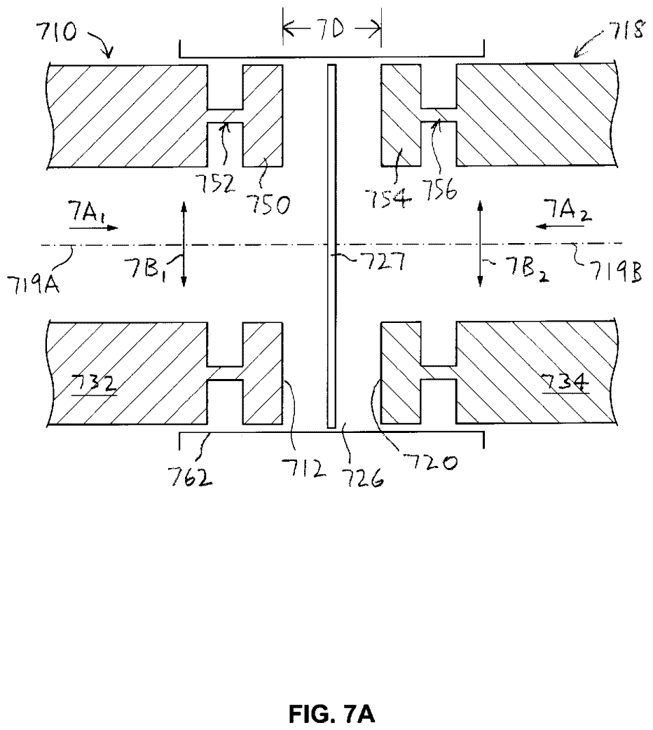

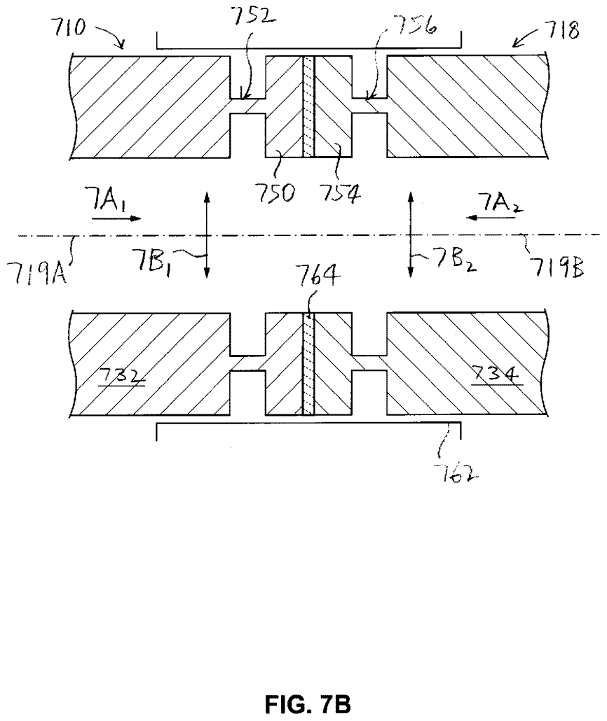

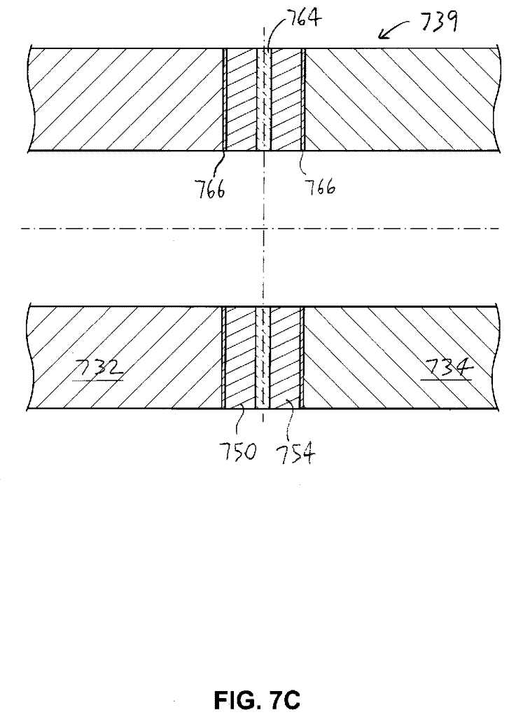

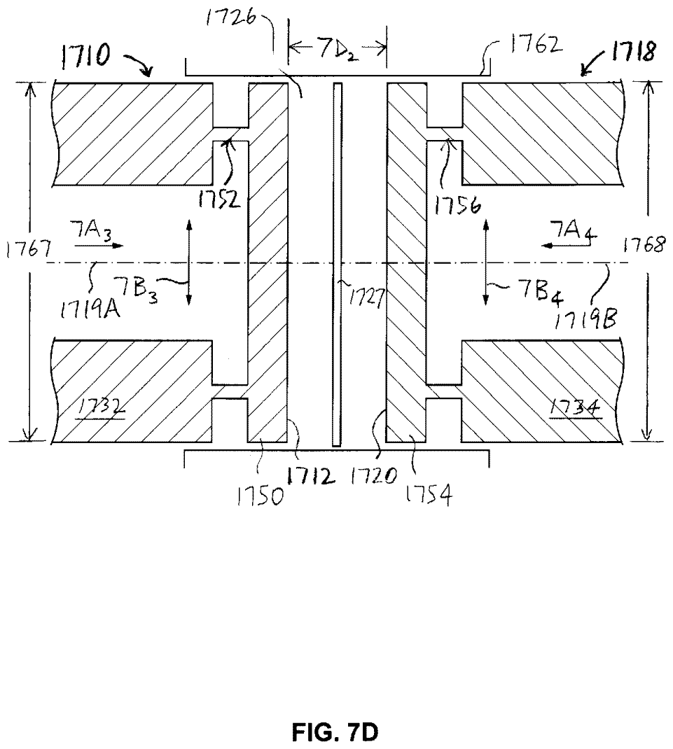

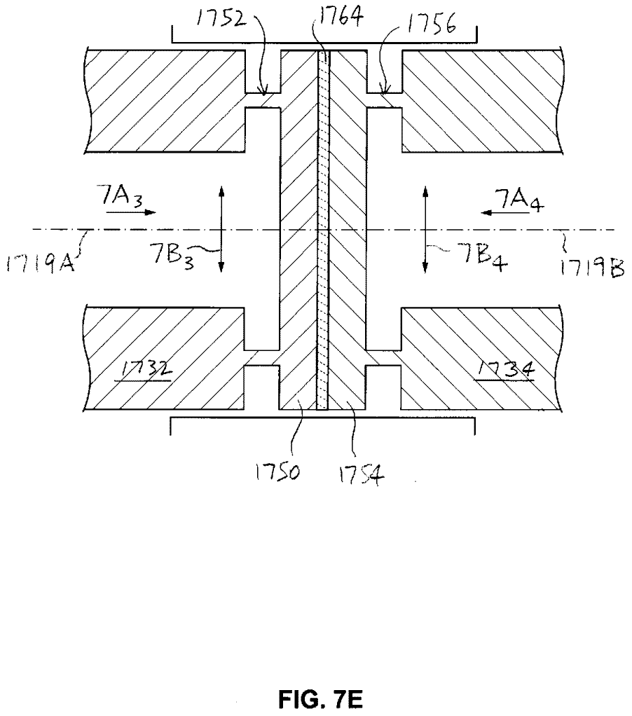

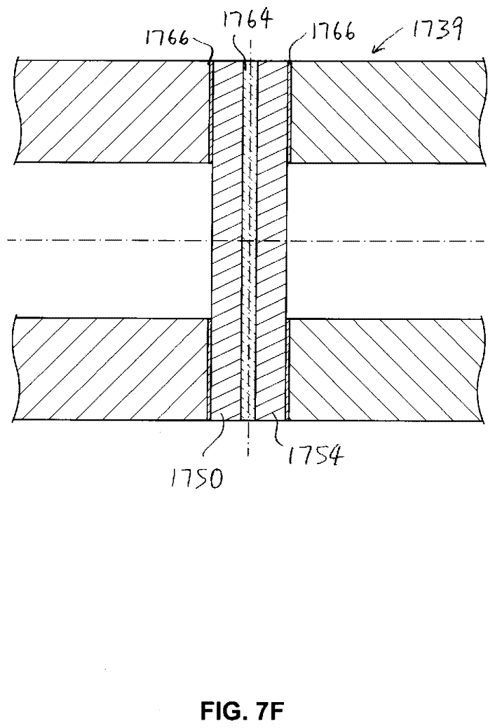

In another embodiment, the workpieces 710, 718 preferably are formed with respective engagement surfaces 712, 720 thereon (FIG. 7A). It will be understood that each of the workpieces 710, 718 is a tube or pipe. The first workpiece 710 include a first body portion 732, and the second workpiece 718 includes a second body portion 734. Preferably, the workpieces 710, 718 are axially aligned, i.e., so that axes 719A, 719B thereof are aligned.

Preferably, the first engagement surface 712 is located on a first engagement portion 750 of the first workpiece 710. The first workpiece 710 preferably also includes a first bridge portion 752 located between the first engagement portion 750 and the first body portion 732, and connected therewith. Similarly, the second workpiece 718 preferably includes a second engagement portion 754, and a second bridge portion 756 that is located between the second engagement portion 754 and the second body portion 734.

It will be understood that, in one embodiment, the first and second workpieces 710, 718 preferably are made of aluminum or another metal with relatively high thermal conductivity.

As can be seen in FIG. 7A, the bridge portions 752, 756 preferably are narrower (in cross-section) than the engagement portions and the body portions to which they are respectively connected. It is believed that the narrower bridge portions 752, 756 restrict, to an extent, the transfer of heat from the engagement portions 750, 754 to the respective body portions 732, 734.

Preferably, the first and second workpieces 710, 718 are positioned to locate the engagement surfaces 712, 720 a predetermined distance “7D” apart, facing each other to define a gap 726 therebetween. One or more heating elements 727 preferably are positioned in the gap 726. As will be described, one or more guide elements 762 preferably are provided, for guiding each of the workpieces 710, 718 when they are moved toward each other. At least the engagement portions 750, 754, the bridge portions 752, 756, and the body portions 732, 734 preferably are covered or enveloped by an inert (non-oxidizing) gas, or inert gases. The inert gas and one or more coverings or containers holding the inert gas in place are omitted from FIGS. 7A-7C for clarity of illustration.

The heating elements 727 are energized to heat initially heated portions 728, 730 of the respective workpieces 710, 718 to a hot working temperature, at which the initially heated portions 728, 730 are plastically deformable. It will be understood that the heating elements may utilize any suitable form of heating (e.g., induction, or radiant heating). Once the heated portions 728, 730 are at the hot working temperature, the heating elements 727 are removed.

In one embodiment, the initially heated portions 728, 730 may include at least parts of the bridge portions 752, 756. However, for clarity of illustration, the initially heated portions 728, 730 are illustrated in FIG. 7A as being limited to the engagement portions 750, 754, at least for a short time period immediately after the heating elements are removed.

As can be seen in FIGS. 7A and 7B, while the heated portions 728, 730 are heated to the hot working temperature, one or both of the first and second workpieces 710, 718 are subjected to a translocation motion, indicated by arrows “7A₁”, “7A₂”, to bring the engagement surfaces 712, 720 together, to engage each other. The workpieces 710, 718 are guided by the guide elements 762 as the workpieces 710, 718 are moved, to keep them axially aligned. In one embodiment, once engaged, the workpieces 710, 718 are continuously urged together, until the first and second workpieces 710, 718 are bonded together, as will be described.

Preferably, one or both of the workpieces 710, 718 are subject to an engagement motion, as schematically indicated by arrows “7B₁”, “7B₂”. It will be understood that the engagement motion may be any suitable motion of one workpiece relative to the other. For instance, the engagement motion may include motion in the z direction, i.e., motion orthogonal to the plane of the drawing.

Due to the engagement motion while the engagement surfaces 712, 720 are engaged, the engagement surfaces 712, 720 are plastically deformed, and temporarily form a layer 764 of generally plastic material, as shown in FIG. 7B. It will be understood that the thickness of the layer 764 of plastically deformable material has been exaggerated in FIG. 7B, for clarity of illustration.

Those skilled in the art would appreciate that heat energy is transferred by conduction from the initially heated portions 728, 730 to the respective bridge portions 752, 756 that are connected therewith. Also, because the hot working temperature may be a range of temperatures that are less than a melting temperature, the bridge portions 752, 756 may be at a hot working temperature that is somewhat less than the hot working temperature of the initially heated portions 728, 730. As a result, after the plastic material layer 764 is formed, the balance of the engagement portions 750, 754 and the bridge portions 752, 756 are also at a hot working temperature.

The workpieces 710, 718 are urged against each other, causing the bridge portions 752, 756 collapse to temporarily form respective second layers 766 of generally plastic material (FIG. 7C). One or more of the workpieces are moved relative to each other, to shear the layers 766, for plastic deformation thereof to produce a recrystallized substantially uniform microstructure therein.

The workpieces 710, 718 are then allowed to cool to ambient temperature, and the workpieces 710, 718 are bonded together when the layers 764, 766 cool, as described above, to form a product 739 (FIG. 7C). In the same manner as described above, the workpieces are metallurgically bonded or joined together over a region “7R” of the product 739 in which the microstructure is characterized by recrystallized substantially uniform grain sizes.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 712, 720 of the first and second workpieces 710, 718 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

In an alternative embodiment of the method of the invention, the translocation motion may be briefly paused after the engagement surfaces are initially engaged. That is, after the initial engagement of the engagement surfaces 712, 720 with each other and the layer 764 of temporarily plastic material is formed, for a short predetermined time period, the workpieces are not further urged together, although they are engaged with each other. The engagement motion may continue during this short predetermined time period, i.e., the layer 764 may be subjected to shearing at this time.

It is believed that, during the short predetermined time period, heat may be further transferred by conduction into the bridge portions 752, 756, i.e., from the initially heated portions 728, 730 respectively connected therewith. In addition, the material 764 preferably solidifies in the short predetermined time period. After the short predetermined period, the workpieces are again urged against each other (i.e., in the directions indicated by arrows “7A₁” and “7A₂”), and the engagement motion recommences, resulting in the workpieces being joined or bonded together to form the product 739. Alternatively, after the short predetermined period, the engagement motion continues (or is recommenced, as the case may be) and the workpieces are subsequently urged against each other.

In another embodiment, the workpieces 1710, 1718 preferably include respective first and second engagement portions 1750, 1754 with respective engagement surfaces 1712, 1720 thereon (FIG. 7D). As can be seen in FIG. 7D, the first and second engagement portions 1750, 1754 preferably extend across, or extend substantially across, respective diameters 1767, 1768 of the first and second workpieces 1710, 1718. The first workpiece 1710 includes a first body portion 1732, and the second workpiece 1718 includes a second body portion 1734. Preferably, the workpieces 1710, 1718 are axially aligned, so that axes 1719A, 1719B thereof are aligned.

Preferably, the first engagement surface 1712 is located on a first engagement portion 1750 of the first workpiece 1710. The first workpiece 1710 preferably also includes a first bridge portion 1752 located between the first engagement portion 1750 and the first body portion 1732, and connected therewith. Similarly, the second workpiece 1718 preferably includes a second engagement portion 1754, and a second bridge portion 1756 that is located between the second engagement portion 1754 and the second body portion 1734.

It will be understood that the first and second workpieces 1710, 1718 preferably are made of aluminum or another metal with relatively high thermal conductivity.

As can be seen in FIG. 7D, the bridge portions 1752, 1756 preferably are narrower than the engagement portions and the body portions to which they are respectively connected. It is believed that the narrower bridge portions 1752, 1756 restrict, to an extent, the transfer of heat from the engagement portions 1750, 1754 to the respective body portions 1732, 1734.

Preferably, the first and second workpieces 1710, 1718 are positioned to locate the engagement surfaces 1712, 1720 a predetermined distance “7D₂” apart, to define a gap 1726 therebetween. One or more heating elements 1727 preferably are positioned in the gap 1726. As will be described, one or more guide elements 1762 preferably are provided, for guiding each of the workpieces 1710, 1718 when they are moved toward each other. The engagement surfaces 1712, 1720 and at least the engagement portions 1750, 1754 and the bridge portions 1752, 1756 preferably are covered or enveloped by an inert gas. The inert gas and one or more coverings or containers holding the inert gas in place are omitted from FIGS. 7D-7F for clarity of illustration.

The heating elements 1727 are energized to heat initially heated portions 1728, 1730 of the respective workpieces 1710, 1718 to a hot working temperature, at which the initially heated portions 1728, 1730 are plastically deformable. Once the initially heated portions 1728, 1730 are at the hot working temperature, the heating elements 1727 are removed.

In one embodiment, the initially heated portions 1728, 1730 may include at least parts of the bridge portions 1752, 1756. However, for clarity of illustration, the initially heated portions 1728, 1730 are illustrated in FIG. 7D as being limited to the engagement portions 1750, 1754, at least for a short time period immediately after the heating elements are removed.

As can be seen in FIGS. 7D and 7E, once the heated portions are heated to the hot working temperature, one or both of the first and second workpieces 1710, 1718 are subjected to a translocation motion, indicated by arrows “7A₃”, “7A₄”, to bring the engagement surfaces 1712, 1720 together, engaging each other. The workpieces 1710, 1718 are guided by the guide elements 1762 as the workpieces are moved, to keep them axially aligned. In one embodiment, once engaged, the workpieces 1710, 1718 are continuously urged together, until the first and second workpieces 1710, 1718 are bonded together, as will be described.

Preferably, one or both of the workpieces 1710, 1718 are also subject to an engagement motion, as schematically indicated by arrows “7B₃”, “7B₄”. It will be understood that the engagement motion may be any suitable motion of one workpiece relative to the other. For instance, the engagement motion may include motion in the z direction, i.e., motion orthogonal to the plane of the drawing.

Due to the engagement motion while the engagement surfaces 1712, 1720 are engaged, the engagement surfaces 1712, 1720 are plastically deformed, and temporarily form a layer 1764 of generally plastic material, as shown in FIG. 7E. It will be understood that the thickness of the layer 1764 has been exaggerated in FIG. 7E, for clarity of illustration.

Those skilled in the art would appreciate that heat energy is transferred by conduction from the initially heated portions 1728, 1730 to the respective bridge portions 1752, 1756 that are connected therewith. Also, because the hot working temperature may be a range of temperatures that are less than a melting temperature, the bridge portions 1752, 1756 may be at a hot working temperature that is somewhat less than the hot working temperature of the initially heated portions 1728, 1730. As a result, after the plastic material layer 1764 is formed, the balance of the engagement portions 1750, 1754 and the bridge portions 1752, 1756 are also at a hot working temperature.

The workpieces 1710, 1718 are urged against each other, and the bridge portions 1752, 1756 collapse to temporarily form respective second layers 1766 of generally plastic material (FIG. 7F). The workpieces 1710, 1718 are then allowed to cool to ambient temperature, and the workpieces 1710, 1718 are bonded together when the layers 1764, 1766 cool, as described above, to form a product 1739 (FIG. 7F).

The workpieces are bonded together over a region “7R₂” of the product 1739 in which the microstructure is characterized by recrystallized substantially uniform grain sizes.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 1712, 1720 of the first and second workpieces 1710, 1718 may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

In an alternative embodiment of the method of the invention, the translocation motion may be briefly paused after the engagement surfaces are initially engaged. That is, after the initial engagement of the engagement surfaces 1712, 1720 with each other and the layer 1784 of temporary plastic material is formed, for a short predetermined time period, the workpieces are not further urged together, although they are engaged with each other. The engagement motion may continue during this short predetermined time period, i.e., the layer 1764 may subjected to shearing at this time.

It is believed that, during the short predetermined time period, heat may be further transferred by conduction into the bridge portions 1752, 1756, i.e., from the initially heated portions 1728, 1730 respectively connected therewith. In addition, the material 1764 preferably solidifies in the short predetermine time period. After the short predetermined time period, the workpieces are again urged against each other, and the engagement motion recommences, resulting in the workpieces being bonded together to form the product 1739. Alternatively, after the short predetermined period, the engagement motion continues (or is recommenced, as the case may be) and the workpieces are subsequently urged against each other.

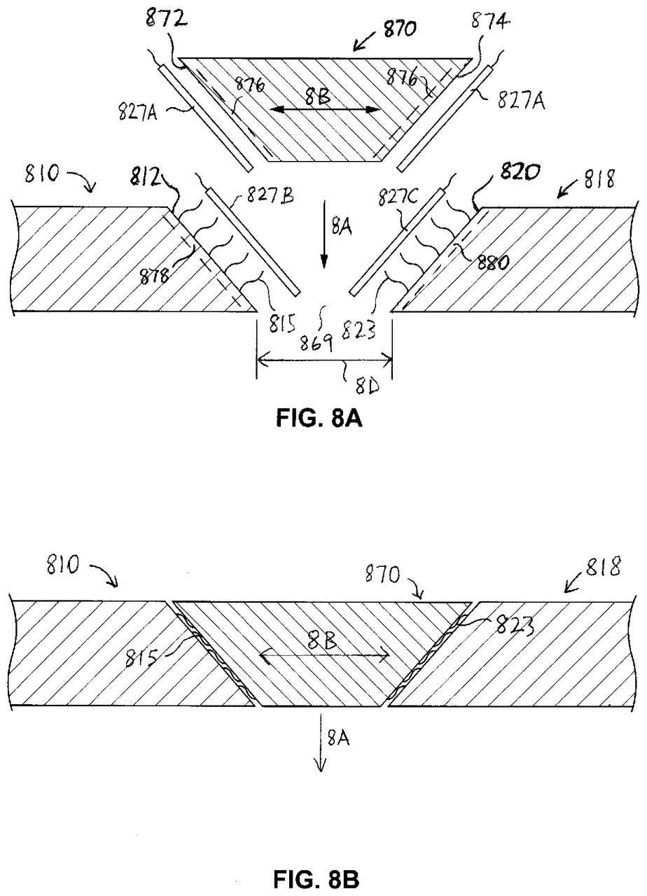

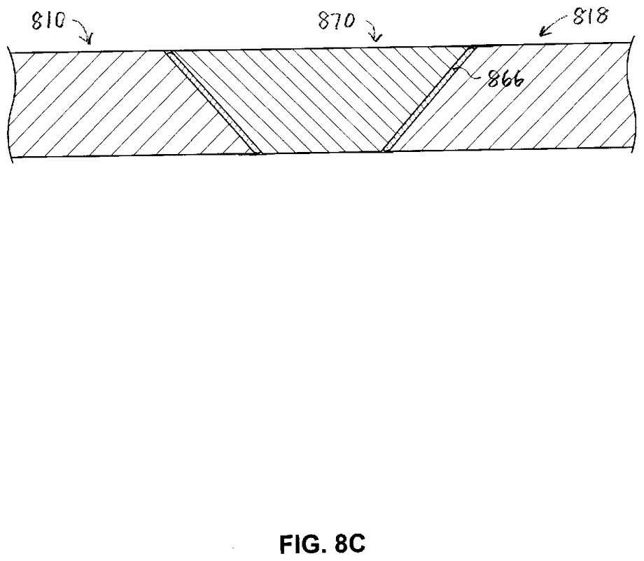

In another alternative embodiment, two workpieces 810, 818 are provided, with a third workpiece 870 formed to fit therebetween (FIG. 8A).

Preferably, the first and second workpieces 810, 818 have respective first and second engagement surfaces 812, 820 on which respective fins 815, 823 are mounted. The fins 815, 823 extend from the respective first and second engagement surfaces 812, 820 (FIG. 8A). The third workpiece 870 has third and fourth engagement surfaces 872, 874 that are formed to fit onto the first and second engagement surfaces 812, 820 respectively, with the fins therebetween.

It will be understood that the workpieces 810, 818, 870 preferably are made of aluminum or another metal with relatively high thermal conductivity.

Preferably, the first and second workpieces 810, 818 are positioned a predetermined distance “8D” apart, to define a gap 869 therebetween (FIG. 8A).

As can be seen in FIG. 8A, the third workpiece 870 preferably is initially positioned outside the gap 869, spaced apart from the engagement surfaces 812, 820 of the first and second workpieces 810, 818. Preferably, one or more third heating elements 827A are positioned proximal to the engagement surfaces 872, 874 of the third workpiece 870.

It is also preferred that one or more first and second heating elements 827B, 827C are positioned proximal to the fins 815, 823 and the engagement surfaces 812, 820.

The third heating element 827A is for heating a third heated portion 876 of the workpiece 870 to a hot working temperature. The first and second heating elements 827B, 827C are for heating first and second heated portions 878, 880 of the first and second workpieces 810, 818 respectively. It will be understood that the heating elements 827A, 827B, 827C may utilize any suitable method of heating (e.g., induction, or radiant heating). When the heated portions are at the hot working temperature, the material therein is plastically deformable. It will be understood that, as illustrated in FIG. 8A, the sizes of the heated portions 876, 878, 880 are exaggerated, for clarity of illustration. It will also be understood that the first and second heated portions 878, 880 preferably include at least parts of the fins 815, 823, and may or may not also include parts of the engagement surfaces 812, 820.

The engagement surfaces 812, 820 and the fins mounted thereon and the second heating elements 827B preferably are covered or enveloped by an inert atmosphere. Similarly, the engagement surfaces 872, 874 and the heating elements 827A preferably are covered or enveloped by an inert atmosphere. It will be understood that the inert atmosphere and a cover or container to hold the inert atmosphere in place are omitted from FIGS. 8A-8C for clarity of illustration.

Next, the heating elements are energized, to heat the respective heated portions to the hot working temperature.

Once the heated portions are heated to the hot working temperature, the heating elements 827A, 827B, and 827C preferably are then removed, and the third workpiece 870 is subjected to a translocation motion relative to the other workpieces 810, 818, causing the third workpiece 870 to move in the direction indicated by arrow “8A” in FIG. 8A. In one embodiment, the third workpiece 870 preferably is also subjected to an engagement motion as it is moved toward the workpieces 810, 818, as generally indicated by arrow “8B”.

As can be seen in FIG. 8B, the third workpiece 870 is moved in the direction indicated by arrow “8A” to engage the fins 815, 823 with the complementary engagement surfaces 872, 874 respectively, and the fins 815, 823 are pressed between the complementary engagement surfaces 872, 874 and the first and second engagement surfaces 812, 820 respectively.

As can be seen in FIG. 8A, depending on the initial position of the third workpiece 870 relative to the first and second workpieces 810, 818, the heating elements 827 may be positioned proximal to the complementary engagement surfaces 872, 874 and distal to the fins 815, 823. It is believed that, because the fins 815, 823 are relatively thin, the fins 815, 823 are at or near the hot working temperature when they are engaged by the complementary engagement surfaces 872, 874. It is also believed that the first and second engagement surfaces 812, 820 are heated to at or near the hot working temperature.

While the first, second, and third heated portions are at the hot working temperature, they are engaged with each other (FIG. 8B).

Once so engaged, it is preferred that the third workpiece 870 is subject to the engagement motion, which may be any suitable relative motion while engaged. The engagement motion is schematically represented by arrow “8B” in FIG. 8B. It will be understood that the engagement motion may be in the z direction, i.e., orthogonal to the plane of the drawing. In addition, after such engagement, the third workpiece 870 is urged in the direction indicated by arrow “8A” in FIG. 8B.

In addition, one or both of the first and second workpieces 810, 818 may be subjected to one or more engagement motions, e.g., relative to the third workpiece 870, while engaged with the third workpiece 870.

Due to the engagement motion and the third workpiece being urged in the direction indicated by arrow “8A” after initial engagement, and because the complementary surfaces 872, 874 and the fins 815, 823 and the engagement surfaces 812, 820 are at or near the hot working temperature when they are engaged, a region 866 of plastically deformable metal is formed therefrom between the third workpiece and the first and second workpieces (FIG. 8C), which is subjected to shear and plastically deformed, while at the hot working temperature. It will be understood that the engagement surfaces 812, 820, 872, and 874 are at least partially subsumed in the region 866. The material in the region 866 recrystallizes to form a microstructure with relatively uniform grain sizes, and once the region 866 is below the hot working temperature, the third workpiece 870 is metallurgically bonded or joined with the first and second workpieces 810, 818.

In practice, where the highly thermally conductive material is aluminum, an aluminum oxide layer that forms on aluminum in ambient atmosphere may have to be addressed, because the aluminum oxide layer may interfere with bonding. For example, the engagement surfaces 812, 820 of the first and second workpieces 810, 818, and the complementary engagement surfaces 872, 874, may be formed (e.g., by cutting and grinding) shortly before the engagement surfaces are enveloped by the inert atmosphere. Alternatively, the oxide layer may be sufficiently broken up when the engaged materials are subjected to shear, in the absence of cutting or grinding the engagement surfaces.

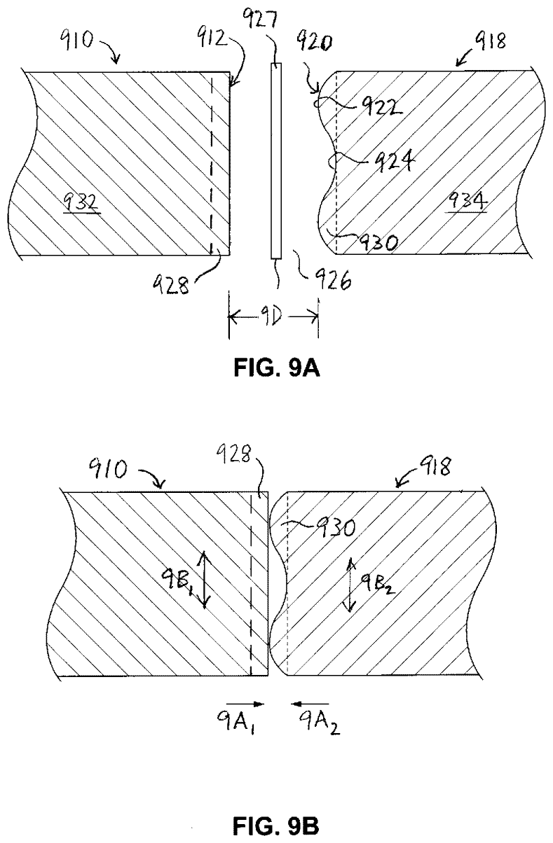

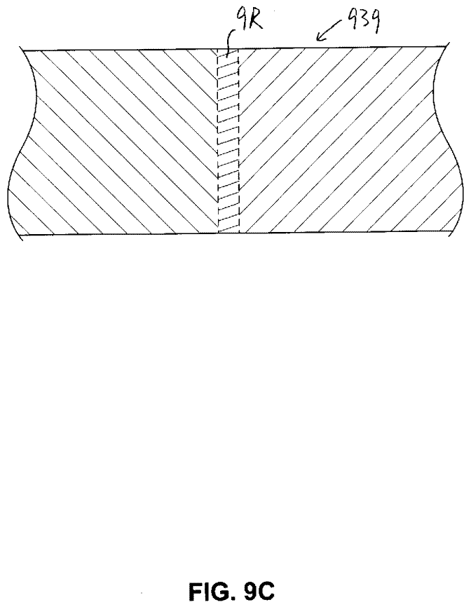

As can be seen in FIGS. 9A and 9B, in one embodiment, the method of the invention includes providing a first workpiece 910 having a first engagement surface 912. Preferably, the first engagement surface 912 defines a plane 929 (FIG. 9A). Also, a second workpiece 918 is provided that has a second engagement surface 920 including a number of alternating second peaks 922 and second troughs 924.

As can be seen in FIG. 9A, the first and second workpieces 910, 918 preferably are positioned a predetermined distance “9D” apart from each other to locate the first and second engagement surfaces 912, 920 facing each other to define a gap 926 therebetween.

One or more heating elements 927 preferably are positioned in the gap 926, for heating respective first and second heated portions 928, 930 of the workpieces 910, 918 to one or more hot working temperatures, at which the first and second heated portions are at least partly plastically deformable. It will be understood that the heating elements 927 may utilize any suitable method of heating (e.g., induction, or radiant heating). As will be described, the first heated portion 928 preferably is located adjacent to the first engagement surface 912. The second heated portion 930 preferably is located adjacent to the second peaks 922 of the second engagement surface 920.

In one embodiment, the first and second workpieces 910, 918 preferably are made of first and second materials (metals) that are not the same. The first and second materials may have different melting points, and they therefore also may be plastically deformable at different hot working temperatures. The two different materials may also have different first and second thermal conductivities respectively. For instance, the first workpiece 910 may be made of steel, and the second workpiece 918 may be made of aluminum.

Preferably, the heating element 927 is energized, and the heated portions 928, 930 are initially heated to the hot working temperature. Upon the first and second heated portions 928, 930 being heated to the hot working temperature, respective first and second body portions 932, 934 are thereby defined in the first and second workpieces 910, 918. The first and second body portions 932, 934 are not initially heated to the hot working temperature. It will be understood that the first and second body portions 932, 934 are those parts of the first and second workpieces 910, 918 that are connected to the first and second heated portions 928, 930 but that are not initially heated to the respective hot working temperatures. However, those skilled in the art would appreciate that, as the first and second heated portions are heated to the hot working temperature, the temperatures of the body portions 932, 934 also increase, primarily due to conduction.

In use, the first and second workpieces 910, 918 are first positioned the distance “9D” apart, and the heating element 927 is located therebetween, as shown in FIG. 9A. Preferably, at least the first and second heated portions 928, 930 are covered with an inert (non-oxidizing) atmosphere during heating and engagement. It will be understood that the inert atmosphere and a container therefor are omitted from the drawings for clarity of illustration.

Next, the heating element 927 preferably is energized, to heat both the first heated portion 928 of the first workpiece 910 and the second heated portion 930 of the second workpiece 918 to the hot working temperature. It will be understood that, if the first and second workpieces are made of respective materials having different melting points, then they are heated to respective first and second hot working temperatures. In order to help achieve this, the heating element(s) 927 may be positioned as required between the workpieces, e.g., the heating element(s) 927 may be positioned other than equidistant from the workpieces.

Once the heated portions 928, 930 are at their respective hot working temperatures, the heating element 927 is removed from the gap 926.

As can be seen in FIGS. 9A and 9B, once the heated portions 928, 930 are at the respective hot working temperatures, one or both of the first and second workpieces 910, 918 preferably are subjected to a translocation motion, as indicated by arrows “9A₁” and “9A₂” in FIG. 9B. Due to the translocation motion, the engagement surfaces 912, 920 are engaged with each other. It will be understood that both of the workpieces may be subjected to the translocation motion, or only one of them, i.e., the first workpiece 910, or the second workpiece 918, or both, may be moved toward the other.

While the first and second heated portions are at the respective hot working temperatures and the first and second engagement surfaces are engaged, the first and second engagement surfaces preferably are urged together, i.e., in the directions indicated by arrows “9A₁” and “9A_{2”}.

It is also preferred that one or both of the first and second workpieces 910, 918 are subjected to an engagement motion, while the heated portions 28, 30 are at the respective hot working temperatures, and engaged with each other, and urged together (FIG. 9B). The relative engagement motion of one or both of the first and second workpieces 910, 918 is schematically indicated by arrows “9B₁” and “9B₂” in FIG. 9B. Such motion is possible while the heated portions are plastically deformable, i.e., while they are at the hot working temperature. It will also be understood that motion in a z direction (i.e., orthogonal to the plane of the drawing) is possible.

The engagement motion may be any type of motion of one or both of the engaged first and second workpieces 910, 918 relative to the other, whether regularly repeated or not. While the first and second workpieces 910, 918 are engaged with each other, it is preferred that they are pressed against each other, i.e., upon engagement, the workpieces 910, 918 are urged together, in the opposed directions indicated by arrows “9A₁” and “9A₂” in FIG. 9B. After the engagement surfaces 912, 920 are engaged with each other, and the workpieces 910, 918 are subjected to the engagement motion, the workpieces 910, 918 preferably are continuously urged against each other until they are bonded together, as will be described.

Those skilled in the art would appreciate that the peaks 922 and troughs 924 are configured to limit the transfer of heat by conduction from the heated portion 930 to the second body portion 934. The peaks 922 are formed to limit the extent to which the volumes of the heated portion 930 are contiguous with respective volume of the body portion 934, thereby limiting the extent of the heat transfer by conduction from the heated portion 930 to the body portion 934.

It is believed that, because the extent of heat transfer from the heated portion to the body portion is limited, after the heated portion 930 is initially heated to the hot working temperature, the heated portion remains at the hot working temperature for a sufficiently long time to enable it to bond with the heated portion 928 due to the engagement motion, as will be described.

As noted above, in one embodiment, the workpiece 918 may be made of one or more metals or materials with relatively high thermal conductivity. Those skilled in the art would be aware of metals (including alloys) with relatively high thermal conductivity, e.g., aluminum. It will be understood that, as soon as the heated portion 930 is heated to the hot working temperature, there is some transfer of heat energy by conduction from the heated portion 930 to the adjacent parts of the body portion 934.

In the example illustrated in FIGS. 9A-9C, the first workpiece 910 may be made of a metal or material with a relative low thermal conductivity, e.g., steel. Accordingly, although heat transfer from the heated portion 928 to the body portion 932 would commence almost immediately upon heating the heated portion 928, the transfer of heat into the body portion 932 is relatively slower.

From the foregoing, it can be seen that, where the workpieces are made of metals or materials having very different respective thermal conductivities, the workpieces may have engagement surfaces that are configured differently. It will be understood that the engagement surfaces may be configured in any suitable manner, in order to sufficiently limit the rate of heat transfer from the heated portion of a workpiece to its body portion.

It will also be understood that the extent of the peaks 922 and troughs 924 has been exaggerated, for clarity of illustration.

Because the metals of the workpieces may be different, the heated portions 928, 930 may be heated to different first and second hot working temperatures respectively.

It will be understood that the material in the heated portions 928, 930 that are at the one or more hot working temperature are very thin layers, and the thicknesses of the heated portions 928, 930 as illustrated in FIGS. 9A and 9B have been exaggerated for clarity of illustration. As noted above, the engagement surfaces 912, 920 are, after engagement, at their respective hot working temperatures for a brief time period, i.e., the layers are hot enough to be plastically deformed when they first engage each other, for a relatively short time period. The respective engaged heated materials in the heated portions tend to adhere to each other, and the heated material is subjected to shearing due to the engagement motion, while they are engaged and at the hot working temperatures. The shearing action tears the microstructure of the metal in the heated material, to form a region “9R” of metal spanning across the original engagement surfaces 912, 920, and the engagement surfaces are subsumed in the region “9R” (FIG. 9C). In this way, the workpieces 910, 918 are metallurgically bonded or joined together. Recrystallization of the metal takes place as the metal is sheared and cools, and the recrystallization results in a relatively uniformly fine-grained microstructure across the region “9R” (FIG. 9C) at which the workpieces 910, 918 are bonded together, in which the original engagement surfaces are at least partially subsumed.

The region “9R” of metallurgical bonding may be somewhat smaller than the heated portions 928, 930, and may not be generally rectilinear in shape, as illustrated in FIG. 9C. It will be understood that the width of the region “9R” as illustrated in FIG. 9C has been exaggerated for clarity of illustration.

In accordance with the foregoing, the workpieces 910, 918 are joined or bonded together to form a product 939 (FIG. 9C). The first and second workpieces are joined together across the region “9R”, and the microstructure in the region “9R” is a substantially uniform relatively fine-grained microstructure, providing a strong bond.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

I claim:

1. A method comprising:
(a) providing a first workpiece (10) having a first engagement surface (12) comprising a plurality of alternating first peaks (14) and first troughs (16);
(b) providing a second workpiece (18) having a second engagement surface (20) comprising a plurality of alternating second peaks (22) and second troughs (24);
(c) positioning the first and second workpieces a predetermined distance (“D”) apart from each other to locate the first and second engagement surfaces facing each other to define a gap (26) therebetween;
(d) positioning at least one heating element (27) in the gap (26), for heating respective first and second heated portions (28, 30) adjacent to the first and second engagement surfaces (12, 20) at the first and second peaks to a hot working temperature at which the first and second heated portions are plastically deformable, the first and second heated portions being proximal to the first and second peaks, to limit heat transfer therefrom into respective first and second body portions of the first and second workpieces, the first and second body portions being contiguous with the first and second heated portions, and being at temperatures that are less than the hot working temperature respectively;
(e) covering at least the first and second heated portions with an inert atmosphere;
(f) energizing said at least one heating element, to heat the first heated portion of the first workpiece and the second heated portion of the second workpiece to the hot working temperature;
(g) when the first and second heated portions (28, 30) are at the hot working temperature, removing said at least one heating element from the gap, and subjecting one or both of the first and second workpieces to a translocation motion, to engage the first and second engagement surfaces (12, 20) with each other; and
(h) when the first and second heated portions are at the hot working temperature, urging the first and second engagement surfaces together and moving one or more of the first and second engagement surfaces relative to the other in an engagement motion while urged together, for at least partial plastic deformation of the first and second heated portions, to join the first and second workpieces together.

2. The method according to claim 1 in which, in step (c), the first and second workpieces (10, 18) are positioned to align the first peaks with the second troughs, and to align the second peaks with the first troughs.

3. The method according to claim 1 in which, in step (c), the first peaks are aligned with the second peaks, and the first troughs are aligned with the second troughs.

4. The method according to claim 1 in which the first peaks fit in the second troughs and the second peaks fit into the first troughs.

5. The method according to claim 1 in which the first peaks and the second peaks, and the first troughs and the second troughs are rounded.

6. The method according to claim 1 in which the first peaks and the second peaks, and the first troughs and the second troughs are pointed.

7. A method comprising:
(a) providing a first workpiece (410) having a first exposed surface (413), and a plurality of first fins (415) extending from the first exposed surface (413);
(b) providing a second workpiece (418) having a second exposed surface (421), and a plurality of second fins (423) extending from the second exposed surface (421);
(c) positioning the first and second workpieces a predetermined distance (“5D”) apart from each other to locate the first and second exposed surfaces facing each other to define a gap (426) between the workpieces (410, 418);
(d) positioning at least one heating element (427) in the gap (426), for heating respective first and second heated portions (428, 430) extending from respective ends (417, 425) of the fins (415, 423) toward the first and second exposed surfaces (413, 421) to a hot working temperature at which the first and second heated portions are plastically deformable, the first and second heated portions being distal to the exposed surfaces, to limit heat transfer therefrom into respective first and second body portions (432, 434) of the first and second workpieces, the first and second body portions (432, 434) being contiguous with the first and second exposed surfaces (413, 421);
(e) covering at least the first and second heated portions with an inert atmosphere;
(f) energizing said at least one heating element (427), to heat the first heated portion of the first workpiece and the second heated portion of the second workpiece to the hot working temperature;
(g) when the first and second heated portions (428, 430) are at the hot working temperature, removing said at least one heating element from the gap (426), and subjecting one or both of the workpieces to a translocation motion, to engage the first and second fins (415, 423) with each other; and
(h) when the first and second heated portions (428, 430) are at the hot working temperature, urging the first and second heated portions together to push the fins of the first and second workpieces together, and moving one or more of the first and second workpieces relative to the other in an engagement motion while urged together, for at least partial plastic deformation of the first and second heated portions, to join the first and second workpieces together.

8. A method comprising:
(a) providing a first workpiece (610) comprising a highly thermally conductive material and having a first engagement surface (612) comprising a plurality of alternating first peaks (614) and first troughs (616);
(b) providing a second workpiece (618) having a second engagement surface (620) comprising a plurality of alternating second peaks (622) and second troughs (624);
(c) positioning the first and second workpieces a predetermined distance (“6D”) apart from each other to locate the first and second engagement surfaces facing each other to define a gap (626) therebetween;
(d) positioning at least one heating element (627) in the gap, for heating respective first and second heated portions (628, 630) adjacent to the first and second engagement surfaces (612, 620) at the first and second peaks to respective first and second hot working temperatures at which the first and second heated portions (628, 630) are subject to plastic deformation;
(e) covering at least the first and second heated portions with an inert atmosphere;
(f) positioning at least one heat shield element (642, 644) between said at least one heating element and the first engagement surface, for moderating heat transfer to the first heated portion;
(g) energizing said at least one heating element (627), to heat the first heated portion of the first workpiece and the second heated portion of the second workpiece to first and second hot working temperatures;
(h) when the first and second heated portions are at the hot working temperature, removing said at least one heating element from the gap, and subjecting one or both of the workpieces to a translocation motion, to engage the first and second engagement surfaces with each other; and
(i) when the first and second heated portions are at the hot working temperature, urging the first and second engagement surfaces together, and moving one or both of the first and second engagement surfaces relative to the other while urged together, for at least partial plastic deformation of the first and second heated portions, to join the first and second workpieces together.

9. The method according to claim 8 in which:
said at least one heat shield element (642, 644) comprises a body (649, 651) in which openings (646, 648) are formed; and
said at least one heat shield element is positioned to locate the openings opposed to the first and second peaks.

10. The method according to claim 8 in which:
said at least one heat shield element (642, 644) comprises a body (649, 651) in which openings (646, 648) are formed; and
said at least one heat shield element is positioned to locate the openings opposed to the first and second troughs.

11. A method comprising:
(a) providing a first workpiece (710) comprising:
a first engagement portion (750) having a first engagement surface (712) thereon;
a first body portion (732) connected with the first engagement portion (750) by a first bridge portion (752);
(b) providing a second workpiece (718) comprising:
a second engagement portion (754) having a second engagement surface (720) thereon;
a second body portion (734) connected with the second engagement portion (754) by a second bridge portion (756);
(c) positioning the first and second workpieces (710, 718) a predetermined distance (“7D”) apart from each other to locate the first and second engagement surfaces (712, 720) facing each other to define a gap (726) therebetween;
(d) positioning at least one heating element (727) in the gap (726) to heat initially heated portions (728, 730) to a hot working temperature;
(e) covering at least the first and second engagement portions, the first and second body portions, and the first and second bridge portion with an inert atmosphere;
(f) energizing said at least one heating element (727) to heat initially heated portions (728, 730) of the respective workpieces to the hot working temperature, at which the initially heated portions are plastically deformable;
(g) while the first and second heated portions are at the hot working temperature, subjecting one or both of the first and second workpieces to a translocation motion, to engage the engagement surfaces (721, 720) with each other;
(h) while the first and second heated portions are at the hot working temperature, subjecting one or both of the first and second workpieces to an engagement motion, wherein one or both of the first and second workpieces is moved relative to the other while engaged with each other, to form a layer (764) of a first layer of plastically deformable material;
(i) urging the workpieces (710, 718) against each other, to cause the bridge portions (752, 756) to form a second layer (766) of plastically deformable material; and
(j) subjecting the second layer of plastically deformable material to an engagement motion while the first and second workpieces are urged together, for at least partial plastic deformation thereof, to join the first and second workpieces (710, 718) together.

12. The method according to claim 11 in which the first and second engagement portions (1750, 1754) extend across respective diameters of the first and second workpieces (1710, 1718).

13. A method comprising:
(a) providing a first workpiece (810) having a first engagement surface (812), and a plurality of fins (815) extending from the first engagement surface (812);
(b) providing a second workpiece (818) having a second engagement surface (820), and a plurality of fins (823) extending from the second engagement surface (820);
(c) positioning the first and second workpieces a predetermined distance apart from each other to locate the first and second exposed surfaces facing each other, defining a gap between the workpieces (810, 818);
(d) providing a third workpiece (870) having third and fourth engagement surfaces (872, 874) that are formed to fit onto the first and second engagement surfaces (812, 820) respectively;
(e) positioning the third workpiece (870) spaced apart from the first and second workpieces (810, 818);
(f) positioning first and second heating elements (827A, 827B) proximal to the fins (815, 823) and the first and second engagement surfaces (812, 820) respectively, for heating respective first and second heated portions (828, 830) extending from respective ends (817, 825) of the first and second fins (815, 825) toward the first and second engagement surfaces (813, 821) to the hot working temperature at which the first and second heated portions are plastically deformable, to heat transfer therefrom into respective first and second body portions of the first and second workpieces, the first and second body portions being contiguous with the first and second engagement surfaces;
(g) positioning at least one third heating element (827A) proximal to the third and fourth engagement surfaces (872, 874) of the third workpiece (870), for heating a third heated portion to a hot working temperature, at which the third heated portion is plastically deformable;
(h) covering at least the fins (815, 823) and the engagement surfaces (812, 820, 872, 874) with an inert atmosphere;
(i) energizing said at least one first heating element, said at least one second heating element, and said at least one third heating element, to heat the first heated portion, the second heated portion, and the third heated portion respectively to the hot working temperature;
(j) while the first, second, and third heated portions are at the hot working temperature, removing the heating elements from the gaps;
(k) while the first, second, and third heated portions are at the hot working temperature, subjecting the third workpiece to a translocation motion, to engage the third heated portion with the first and second heated portions; and
(l) while the first, second, and third heated portions are at the hot working temperature and urged together, subjecting one or more of the first, second, and third workpieces to one or more engagement motions, for at least partial plastic deformation thereof, to join the third workpiece (870) with the first and second workpieces (810, 818) respectively.

14. A method comprising:
(a) providing a first workpiece (910) having a first engagement surface (912);
(b) providing a second workpiece (918) having a second engagement surface (920) comprising a plurality of alternating second peaks (922) and second troughs (924);
(c) positioning the first and second workpieces a predetermined distance (“9D”) apart from each other to locate the first and second engagement surfaces facing each other to define a gap (926) therebetween;
(d) positioning at least one heating element (927) in the gap (926), for heating respective first and second heated portions (928, 930) adjacent to the first engagement surface (912) and the second engagement surface (920) at the second peaks to at least one hot working temperature at which the first and second heated portions are plastically deformable;
(e) covering at least the first and second heated portions with an inert atmosphere;
(f) energizing said at least one heating element, to heat the first heated portion of the first workpiece and the second heated portion of the second workpiece to said at least one hot working temperature;
(g) when the first and second heated portions (928, 930) are at said at least one hot working temperature, removing said at least one heating element from the gap, and subjecting one or both of the first and second workpieces to a translocation motion, to engage the first engagement surface (912, 920) with the second peaks; and
(h) when the first and second heated portions are at the hot working temperature, urging the first engagement surface and the second peaks together and moving one or more of the first and second engagement surfaces relative to the other in an engagement motion, for at least partial plastic deformation of the first and second heated portions, to join the first and second workpieces together.

15. The method according to claim 14 in which the first workpiece comprises a first material having a first thermal conductivity, and the second workpiece comprises a second material having a second thermal conductivity that differs from the first thermal conductivity.

16. The method according to claim 15 in which the second thermal conductivity is higher than the first thermal conductivity.

17. The method according to claim 14 in which the first engagement surface defines a plane (929).

18. The method according to claim 14 in which the second engagement surface is configured to limit transfer of heat energy from the second heated portion to a body portion of the second workpiece that is contiguous to the second heated portion.
